(19) United States
(12) Patent Application Publication
(10) Pub. No.: US 2024/0303731 A1
(43) Pub. Date: Sep. 12, 2024

(54) METHOD AND SYSTEM FOR CASINO RIM CREDIT AND MARKER PROCESSING

(71) Applicant: Everi Payments Inc., Austin, TX (US)

(72) Inventors: Adam Fong, Las Vegas, NV (US); Steve Nguyen, Las Vegas, NV (US); Shane Taylor, Las Vegas, NV (US); Brendan Shelly, Las vegas, NV (US)

(21) Appl. No.: 18/617,402

(22) Filed: Mar. 26, 2024

Related U.S. Application Data
(63) Continuation of application No. 17/751,438, filed on May 23, 2022.
(60) Provisional application No. 63/195,509, filed on Jun. 1, 2021.

(51) Int. Cl. G06Q 40/03; G06Q 50/34; G07F 17/32

(52) U.S. Cl. CPC G06Q 40/03; G06Q 50/34; G07F 17/3211; G07F 17/3227; G07F 17/3288

(57) ABSTRACT

A method and system are provided for electronically issuing, tracking and processing casino credit, including rim credit and marker credit, and for tracking bets and generating player ratings. The system allows for real-time display of markers, rim credit and their status. The system may link to other systems such as a casino credit system for cross-sharing of information. The system comprises a processing server in communication with one or more mobile processing devices.

### RELATED APPLICATION DATA

The present application is a continuation of U.S. application Ser. No. 17/751,438, filed May 23, 2022, which claims priority to U.S. Provisional Application Ser. No. 63/195,509, filed Jun. 1, 2021, which prior applications are incorporated herein by reference in their entirety.

### FIELD OF THE INVENTION

The present invention relates to method for processing casino markers and other forms of casino credit.

### BACKGROUND OF THE INVENTION

Casinos often advance credit to players for use by the players in making game wagers. Two common forms of credit are known as rim credit and markers. Traditionally, the issuance of markers and rim credit has been a manual process, such as by creating paper records associated therewith. This process is cumbersome and time consuming, and also complicates tracking of such credit by the casino.

An improved method for processing casino markers and other forms of casino credit is desired.

### DESCRIPTION OF THE DRAWINGS

FIG. 1 illustrates one embodiment of a system of the present invention; and

FIGS. 2A-B, 3A-B, 4-5, 6A-B, 7, 8A-B, 9A-B, 10, 11, 12A-H, 13A-I, and 14A-C illustrate examples of screen interfaces or displays that may be displayed in accordance with a method and system of the invention.

### SUMMARY OF THE INVENTION

Embodiments of the invention comprise systems and methods for processing casino credit, such as markers and rim credit, such as facilitating the generation, issuance, tracking and processing of such credit and associated instruments, and exchanging or transferring information between devices and/or systems as part of such generation, issuance, tracking and processing. Additional aspects of the invention comprise systems and methods for automating player rating and player bet tracking.

In one embodiment, a system for electronically processing casino player rim credit comprises a mobile attendant device and a processing server. The mobile attendant device may comprise a processor configured to execute machine readable code, a memory, a display device, at least one user input device and machine-readable code stored in said memory. The processing server may comprise a processor configured to execute machine readable code, a memory, a communication interface, and machine readable code stored in said memory said executable by said processor. The machine readable code of the mobile attendant device may be configured to cause the processor thereof to receive input of rim identification information comprising a designation of a player, a game location and an amount of rim credit provided to the player. The machine readable code of the processing server may be configured to, in response to receiving the rim identification information from the mobile attendant device, cause the processor thereof to generate an electronic rim credit record and transmit information regarding the rim credit record to the mobile attendant device, the information regarding the rim credit record comprising at least a rim credit record identifier, information identifying the player, and the amount of the rim credit.

The system may be configured to facilitate transfer of a player rim credit, such as from one location (such as one gaming table) to another. The system may also be configured to receive information regarding payments against a player's rim credit.

In one embodiment, the system is configured to electronically generate one or more markers. In one embodiment, an electronic marker is created. Funds associated with the marker may be used to pay outstanding amounts associated with a player's rim credit.

Further objects, features, and advantages of the present invention over the prior art will become apparent from the detailed description of the drawings which follows, when considered with the attached figures.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

Embodiments of the invention comprise systems and methods for processing casino credit, such as markers and rim credit, such as facilitating the generation, issuance, tracking and processing of such credit and associated instruments, and exchanging or transferring information between devices and/or systems as part of such generation, issuance, tracking and processing. Additional aspects of the invention comprise systems and methods for automating player rating and player bet tracking.

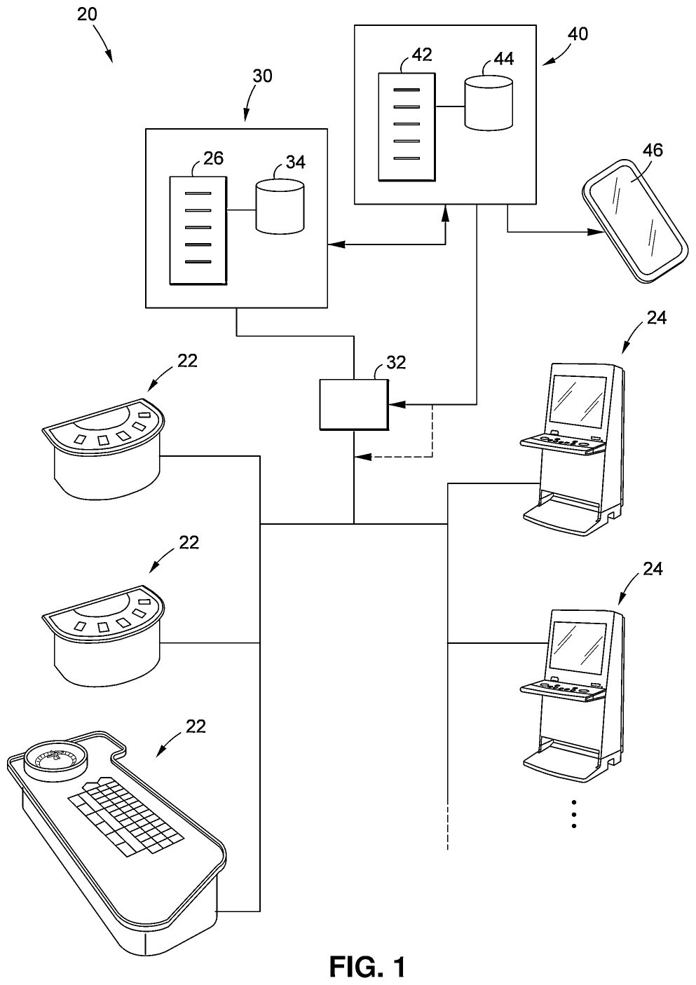

One embodiment of a system 20 of the invention is illustrated in FIG. 1. The system 20 may be referred to as a casino gaming system since it is preferably associated with a casino. It will be appreciated, however, that while various features of the system 20 are preferably located at a casino, other features might be located remote from the casino. Further, not all features of the system 20 need to be operated by a casino, but instead might be operated by one or more vendors or third party service providers to the casino (whether such features and associated functionality is implemented on-premises of the casino, or remotely, such as where functionality may be supported by one or more servers or systems which are located off-property, such as at the location of a vendor, where data may be stored in the cloud, etc.).

The system 20 may include a plurality of gaming devices, such as one or more gaming tables 22. The system 20 may also include other types of gaming devices such as gaming machines 24 (slot machines, video poker machines, etc.) at which one or more games, and preferably wager-based games which offer a player the opportunity for winnings, are presented. In the case of the gaming tables 22, a player may place wagers with one or more monetary value chips and may be paid winnings in the form of chips (or other value or representations of value, such as printed value tickets). Such players may desire to cash out those chips by turning them in for their monetary value (in currency/coins or equivalent funds to their financial account). In electronic table implementations, the gaming tables 22 may be configured to accept electronic monetary value credits for wagering, such as from a player balance of credits. Likewise, the gaming machines 24 might accept wagers in various formats, such in the form of monetary value credits from a credit balance associated with the machine 24, which credit balance might be funded from currency or a value ticket provided to the gaming machine 24, from funds electronically transferred to the gaming machine 24, etc. The system 20 may include a variety of other features, such as a sports book or e-sports venue for accepting sports-related wagers and presenting e-sports wagering events, or a variety of other gaming devices, whether configured to present games which are primarily based upon chance, skill or have components of both.

The system 20 may include a wide variety of other features or elements. For example, the system 20 may include at least one first sub-system 30 (or similar computing devices). Such a sub-system 30 may comprise one or more casino systems (whether operated by the casino or a vendor). As disclosed below, such systems may comprise an accounting system, player tracking system, a casino credit system (such as the casino credit system operated by Casino Credit, LLC, a subsidiary of Everi Payments Inc., of Las Vegas, NV) or the like.

The first sub-system 30 may include at least one first server 26 which comprises one or more processors or controllers, at least one communication device or interface, a database or other data storage device 34, and one or more additional memory or data storage devices (such as separate from the database). In one or more embodiments, the processor(s) is configured to execute one or more instructions, such as in the form of machine readable code (i.e. “software”), to allow the first server 26 to perform various functionality. The software is preferably non-transitory, such as by being fixed in a tangible medium. For example, the software may be stored in the one or more memory devices. One or more of the memory devices may be read-only. In addition, the software may be stored on a removable medium in some embodiments. In general, the one or more memory devices are used as temporary storage. For example, the one or more memory devices may be random access memory or cache memory used to temporarily store some user information and/or instructions for execution by the at least one processor.

The software may comprise one or more modules or blocks of machine-readable code. Each module may be configured to implement particular functionality when executed by the one or more processors, and the various modules may work together to provide overall integrated functionality. Of course, in certain embodiments, it is also possible for some of the functionality to be implemented as hardware, i.e. a processor or chip which is particularly designed to implement the functionality described herein.

In one embodiment, the first server 32 may include (or be linked communicatively at one or more times to) one or more input and/or output devices, such as a keyboard, mouse, touchscreen, video display or the like, whereby the processor may receive information from an operator or servicer of the first server 26 and/or output information thereto. This allows, for example, an operator of the first server 26 to interface with the first server 26 to upgrade, maintain, monitor it, etc. In other embodiments, an operator might interface with the first server 26 via a separate workstation or other device.

In one embodiment, the processor and other elements of the first server 26 may be linked and thus communicate over one or more communication buses. In this manner, for example, the processor may read/receive software from the memory for execution, receive inputs and provide outputs to the various I/O devices, receive information from or output information to external devices via the communication interface, etc. The one or more communication devices or interfaces permit the first server 26 to communicate with the gaming tables 22, gaming machines 24 and/or other gaming devices, and preferably external devices, networks, systems and the like.

The first sub-system 30 may, via the first server 26 (there may be a plurality of different servers which each implement different functionality) be configured to implement a variety of functionality.

In one embodiment, the first sub-system 30 may implement accounting functionality. The accounting functionality might include tracking of wagers made and winnings paid at the gaming machines 24, amounts wagered and won/lost at the gaming tables 22, amounts associated with monetary value tickets issued and redeemed, etc. In this regard, the first sub-system 30 may include other elements. For example, the casino might operate one or more cashier cages. These cages may be used to implement various functionality, such allowing players to cash chips for currency, allowing players to cash checks for chips, allowing players to associate funds (such as from a credit card, bank account or the like) with a wagering account, such as a sports wagering account, casino wagering account or the like. The accounting functionality may thus include tracking the amounts of casino chips issued and redeemed, checks cashed, and facilitating processing thereof, such as for presentment to a financial institution (via traditional presentment, ACH processing, batch digital processing, etc.). The cashier cage may include a cashier workstation, a monetary value dispensing mechanism and other elements.

The first sub-system 30 might also implement player tracking and rewards functionality, such as by generating and maintaining player account for individual players, tracking wagering and other activities of the players, and issuing awards to players based upon their activities, such as points or the like. For example, the first sub-system 30 may include a wagering system 32. Such a system 32 may be configured to facilitate the transfer of funds to the gaming tables 22, gaming machines 24 or other devices (such as from wagering accounts, etc.). The system 32 may also be configured to track activities at the gaming tables 22 and gaming machines 24 or other devices, such as amounts wagered by players and other game play information such as numbers of games played, game outcomes and the like. In this regard, the system 32 may communicate with the controller of each gaming machine 24 and various features of each gaming table 22, whether such is a table controller or individual table features, such as a card shuffler, card shoe, chip reading/tracking system etc.

The first sub-system 30 might implement central credit casino functionality, such as to accept credit applications for players, determine player credit-worthiness of players and determine whether to issue credit to the player and/or underwrite the credit, generate credit lines for players, track amounts of credits issued to players (and other information or actions, such as, but not limited to tracking high/last actions, derogatory status, tracking bank accounts/checks/returns of markers that have been converted to a check for presentment at financial institutions either physically/digitally/electronic transfers/processing, and implementing collection efforts for unpaid amounts).

Preferably, the system 20 also includes a second sub-system 40. In one embodiment, the second sub-system 40 and second server 42 are configured to implement marker (and/or as described below, other credit) processing functionality. The second sub-system 40 may thus be referred to as a marker processing system 40 and the second server 42 might be referred to as a marker server.

Once again, the second sub-system 40 may comprise a number of elements, such as at least one second server 42 and at least one second database 44. The second sub-system 40 may include other elements, such as one or more workstations and the like. The second server 42 once again preferably comprises a processor, a memory, machine-readable code associated with the memory and executable by the processor, and one or more communication interfaces.

In one embodiment, as described in more detail below, the second server 42 may communicate with one or more of the gaming tables 22 or gaming machines 24, or at least features thereof. For example, as illustrated, the second server 42 may be configured to communicate with the wagering system 32 so as to obtain information thereof, such as game play/bet tracking information. In other configurations, the second server 42 might communicate directly with the gaming machine 24 or gaming tables 22 (again, such as to a table controller or individual table features such as a card shuffler, a card shoe, a chip tracking/reading system, signage for displaying game results, bonuses, pay tables or the like). The first sub-system 30 and the second sub-system 40 may also be communicatively linked, such as to permit communications between elements thereof, such as the first server 26 and the second server 42.

In one embodiment, the second sub-system 40 may include one or more portable or mobile processing devices 46. The portable processing devices 46 preferably comprise a processor, a memory, machine-readable code stored in the memory and executable by the processor, at least one display (such as an electronic video display), and at least one user input device, which features may be associated with a housing of the device. The portable processing device 46 preferably also comprises a communication interface, such as a wireless communication interface which allows the device to be portable and still communicate with the second server 42. The portable processing device 46 may be a special purpose device, or might comprise a general purpose computing device such as a tablet or similar device which is then provided with software for implementing the functionality described herein.

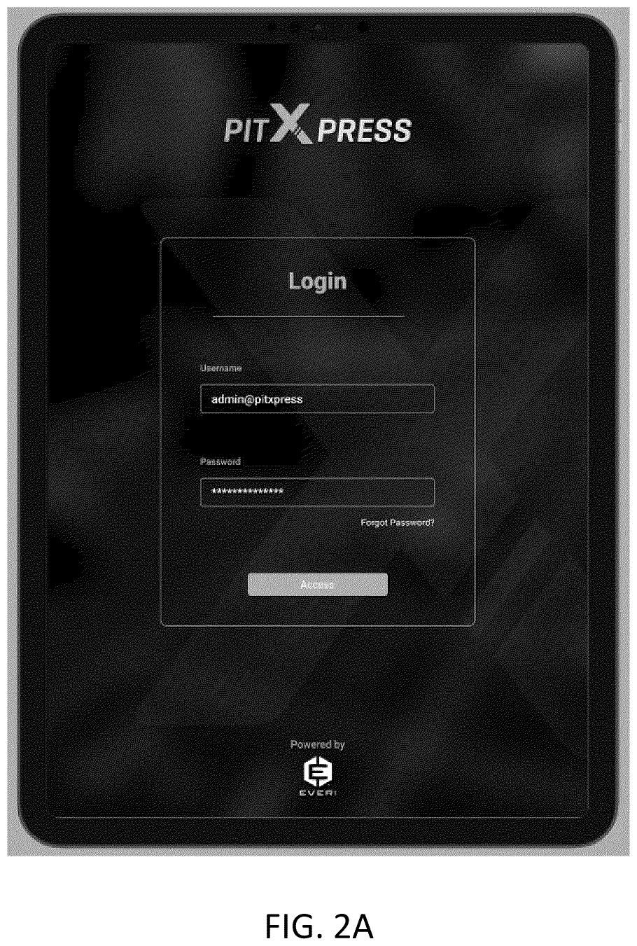

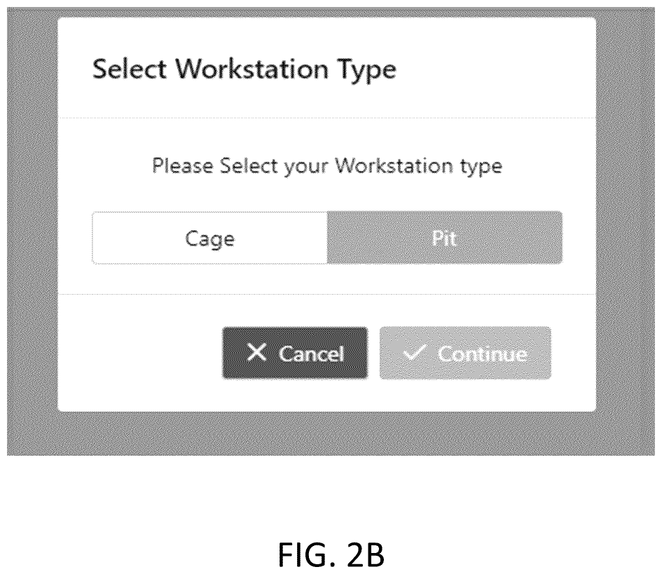

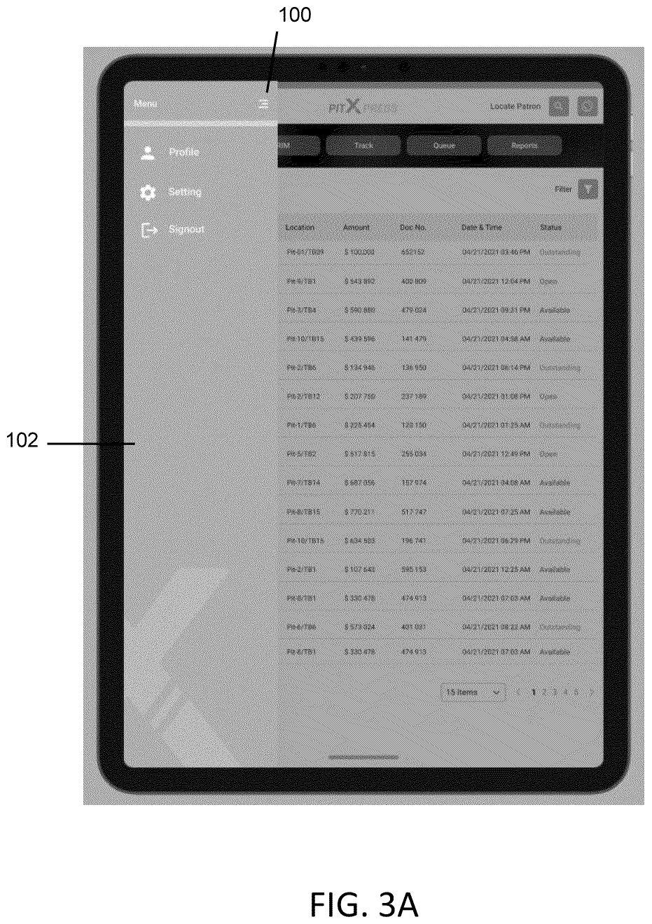

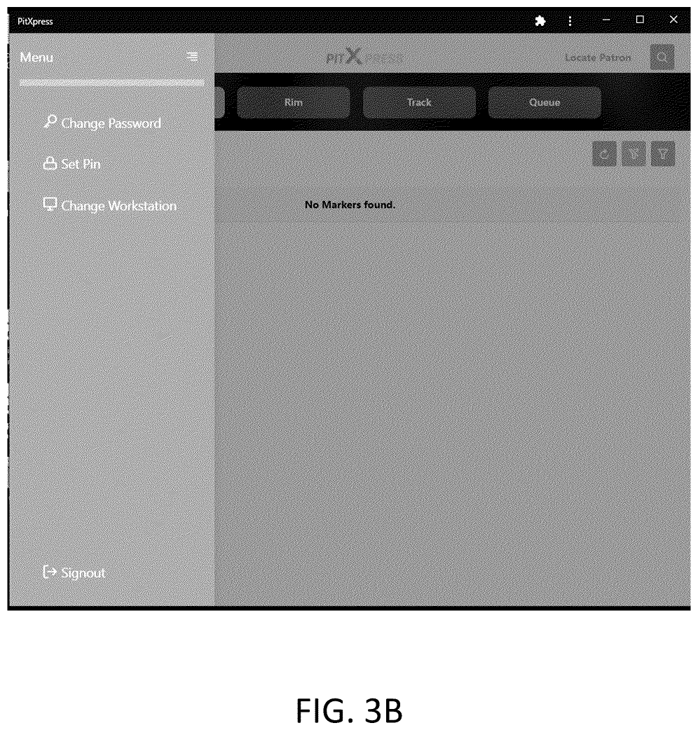

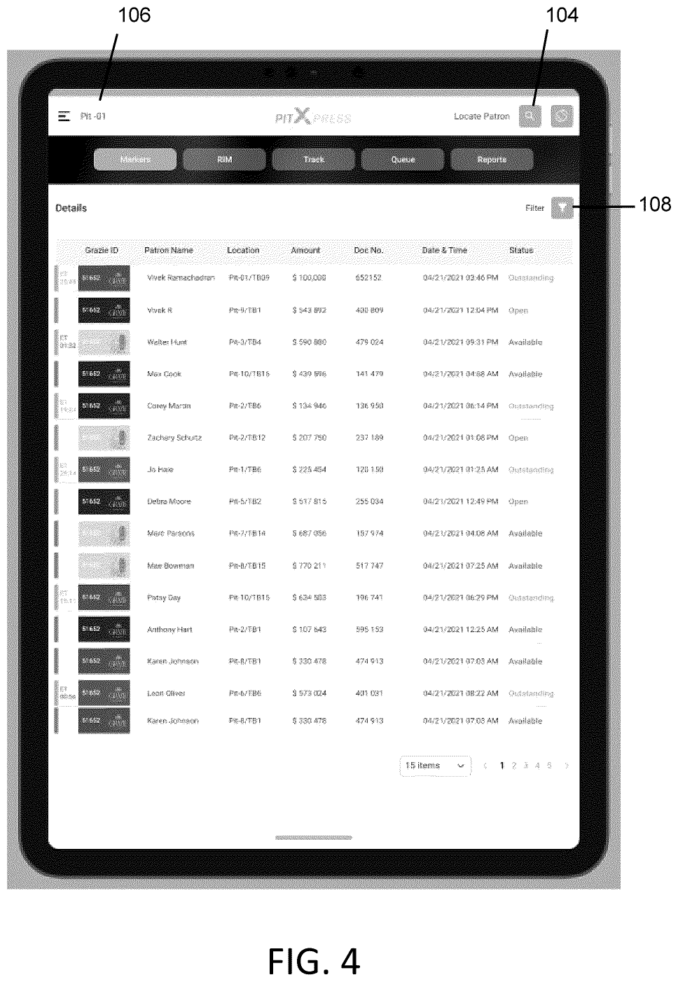

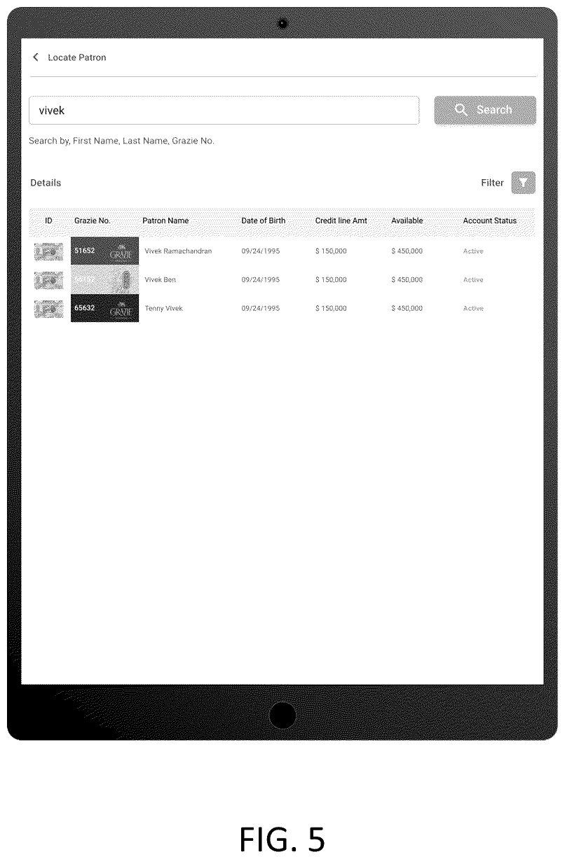

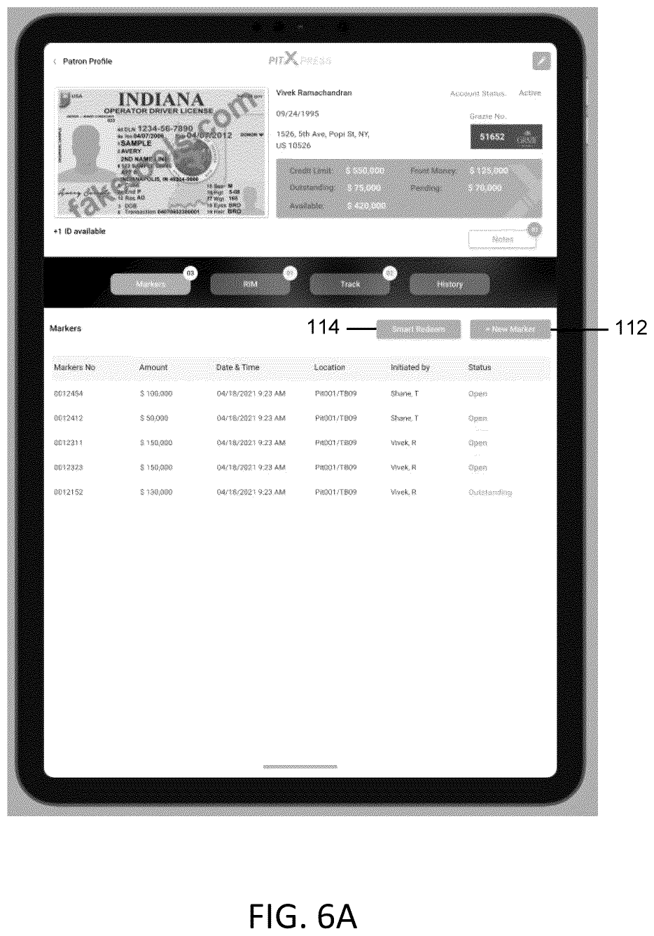

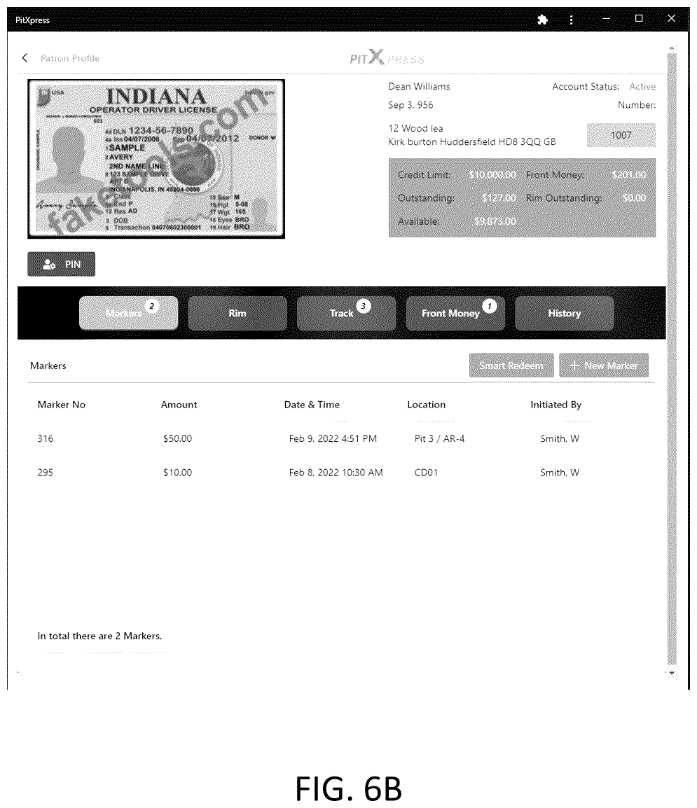

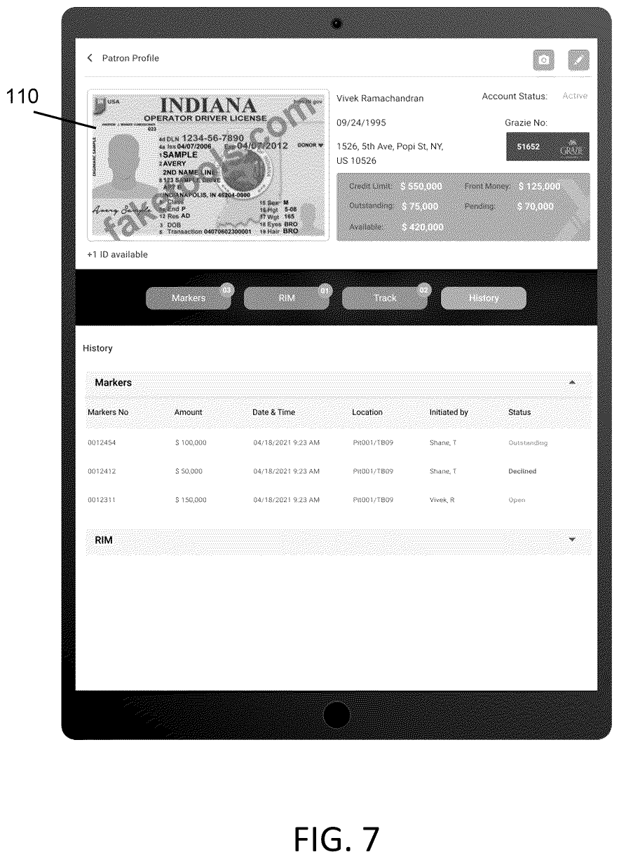

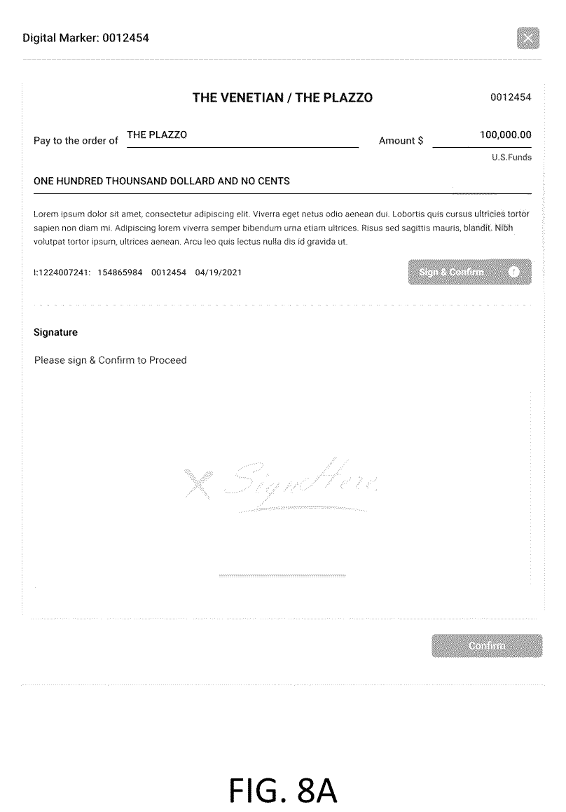

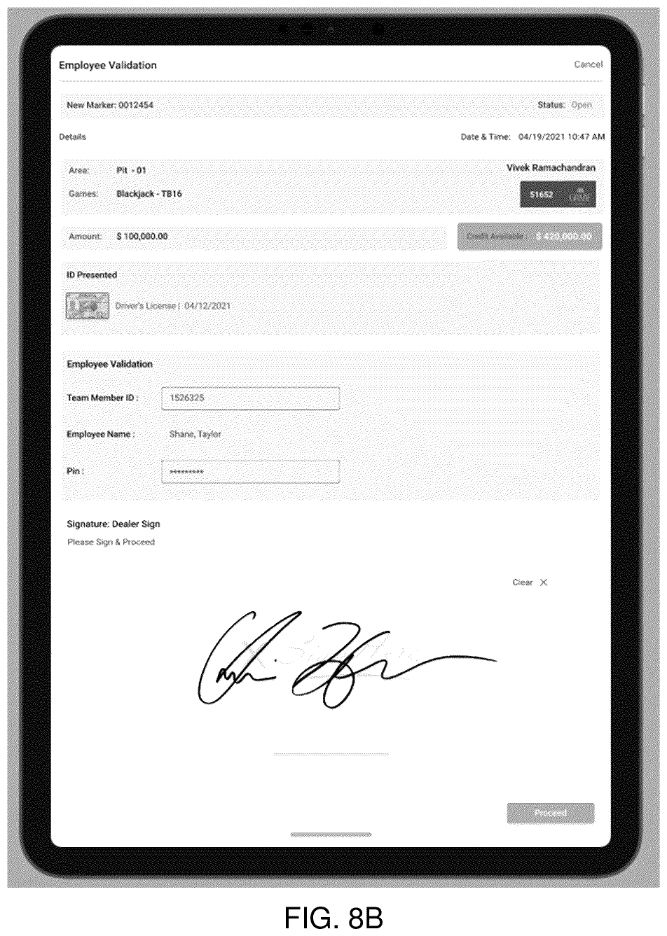

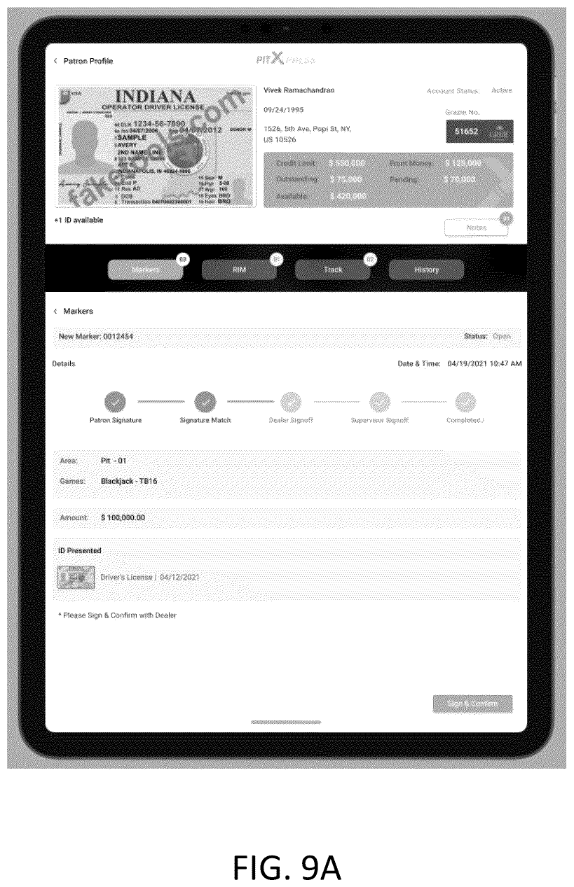

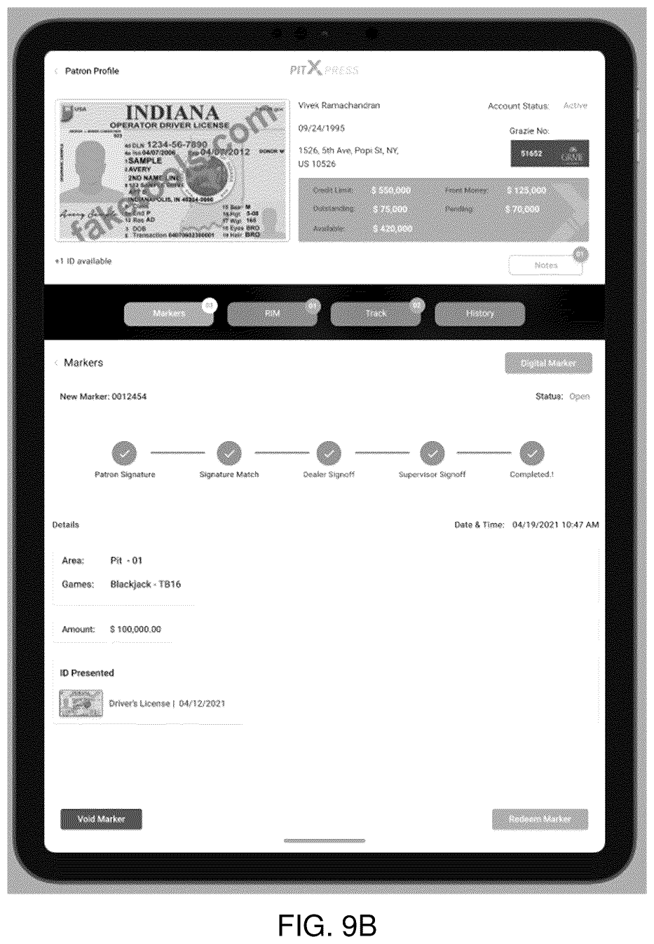

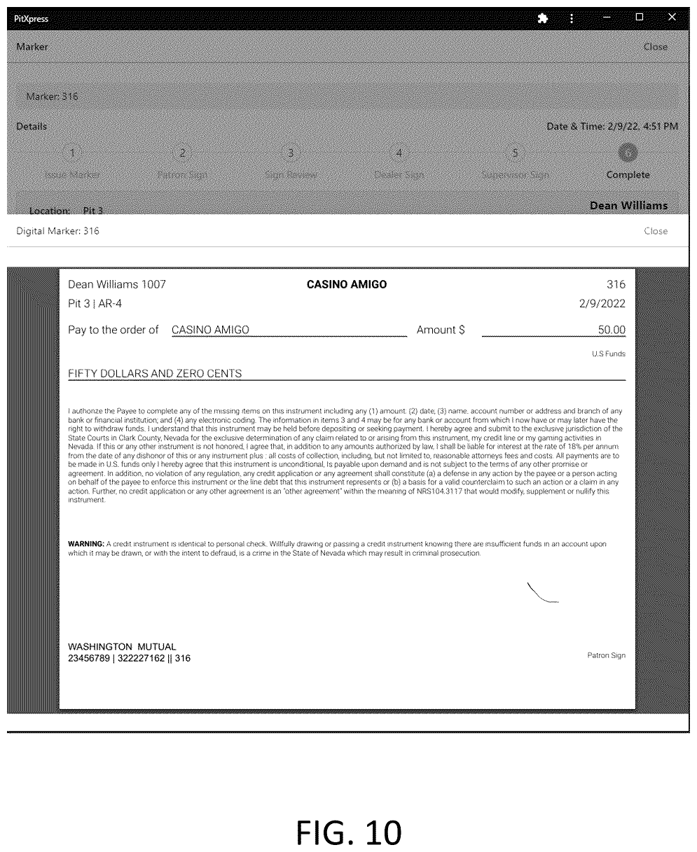

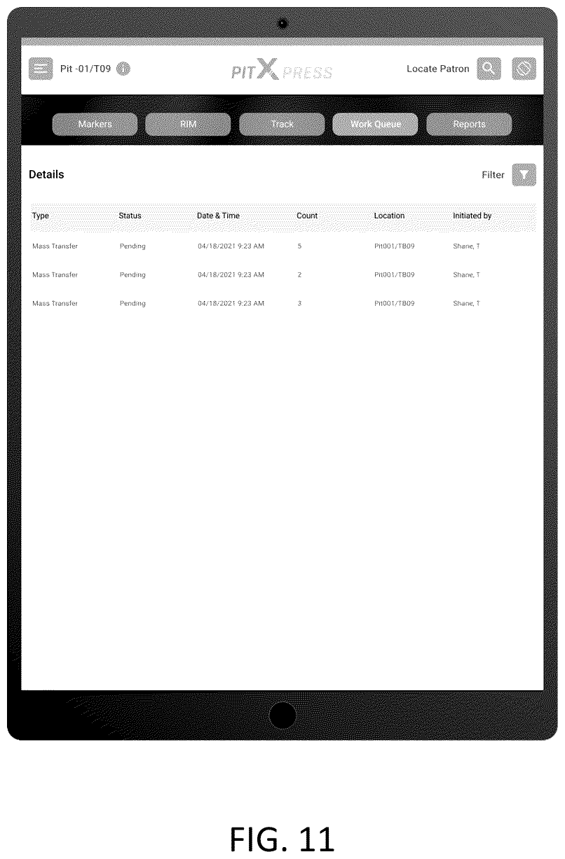

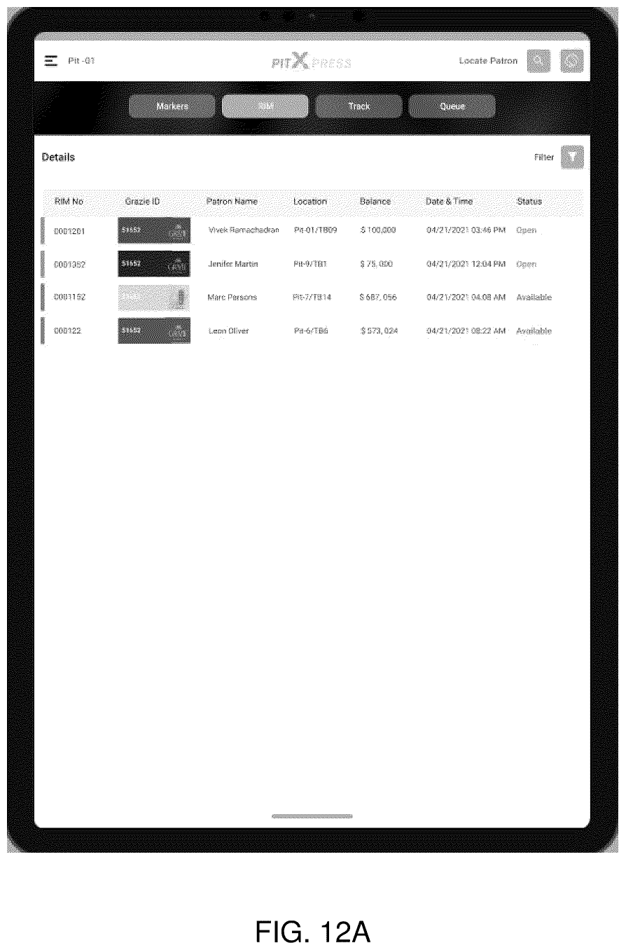

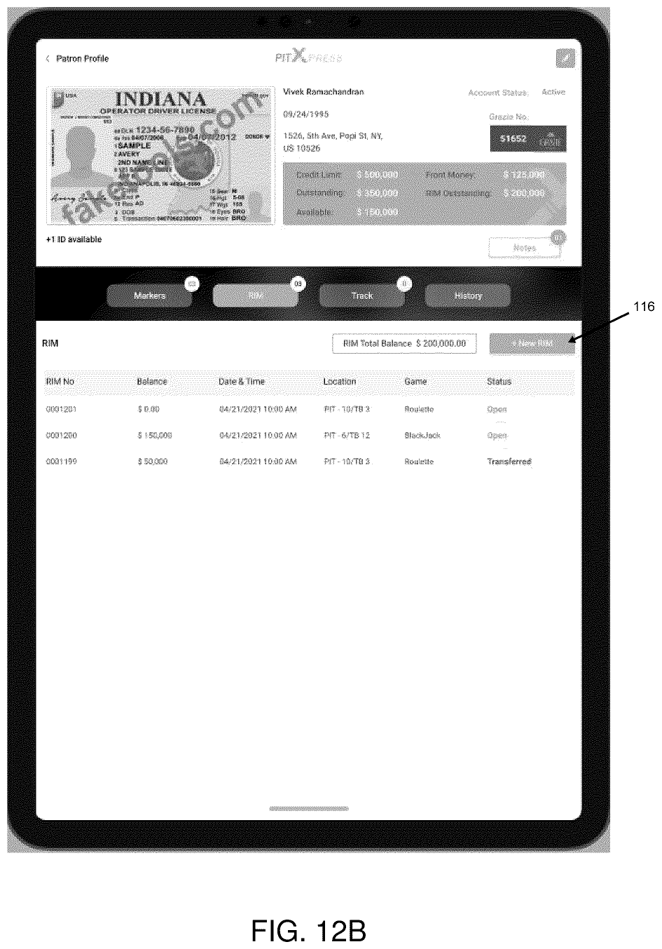

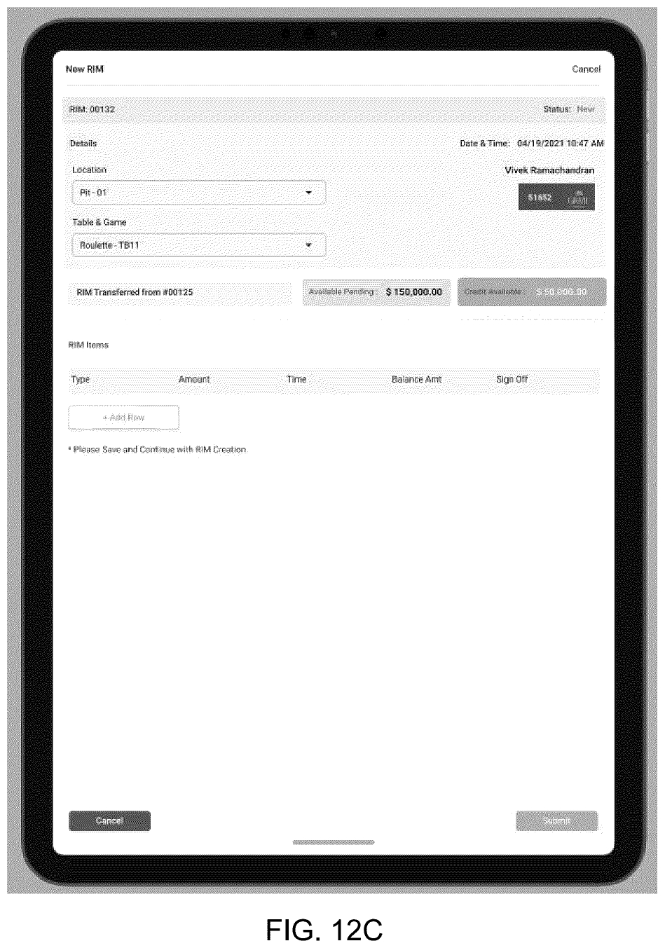

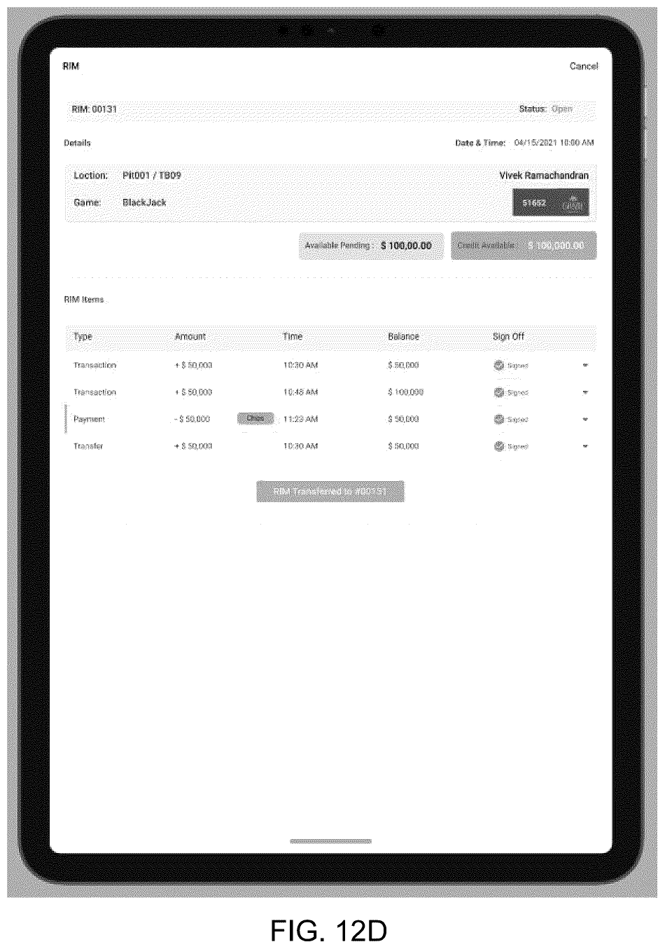

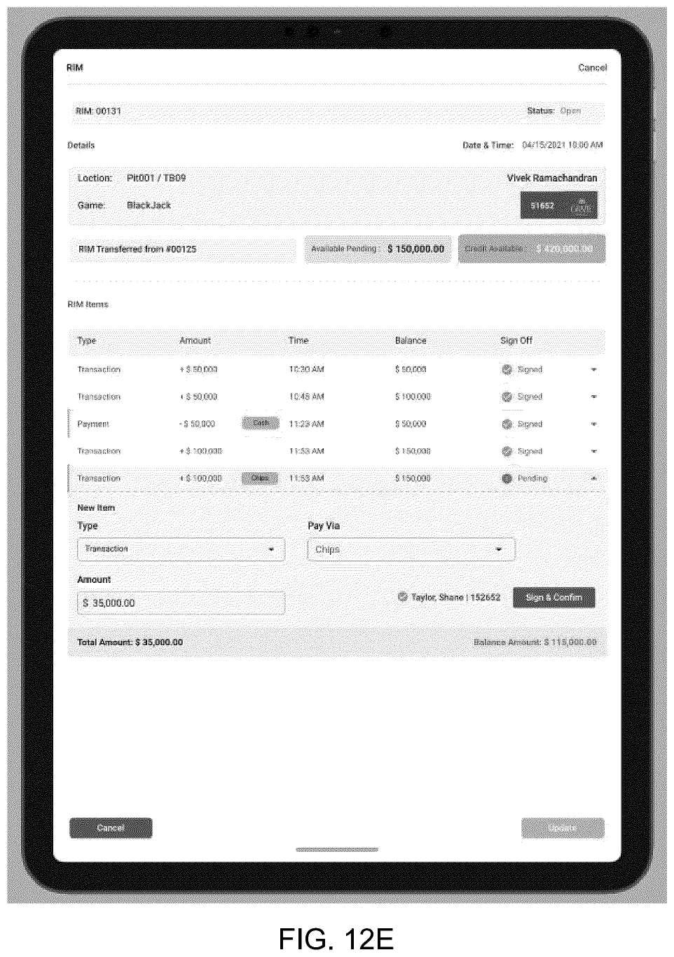

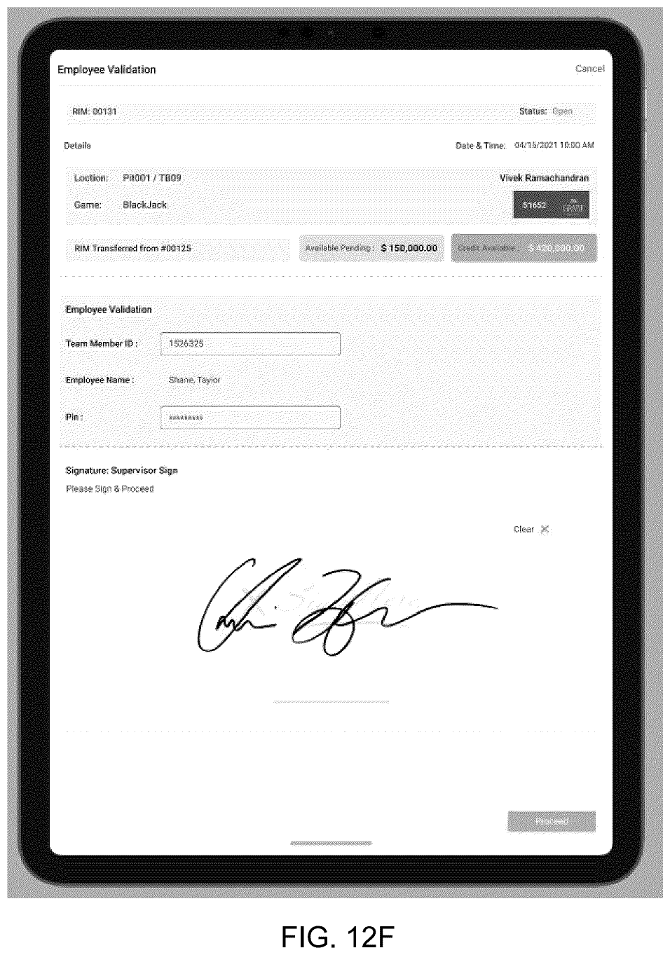

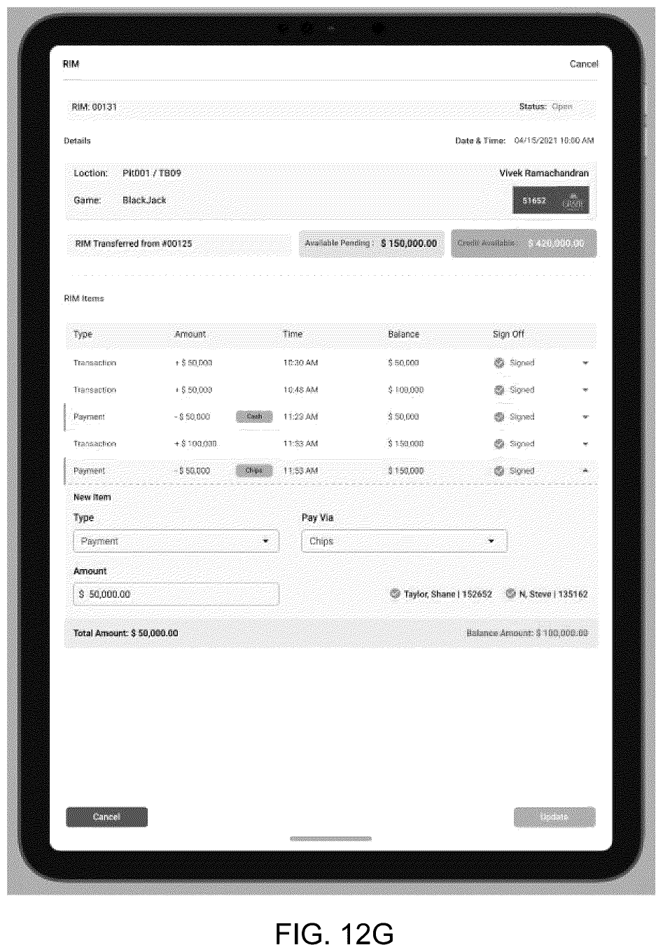

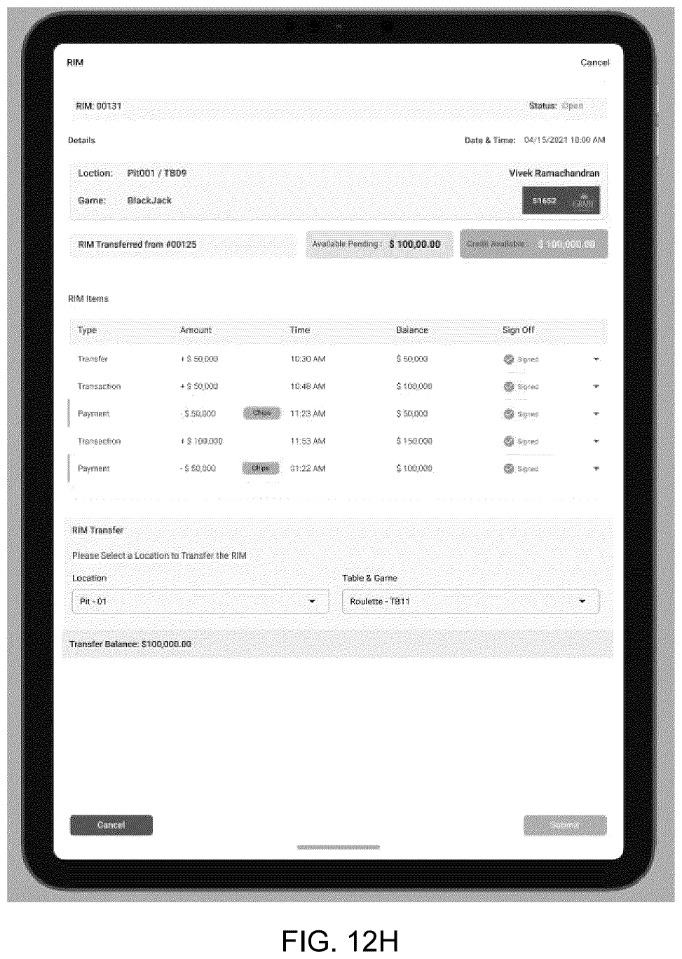

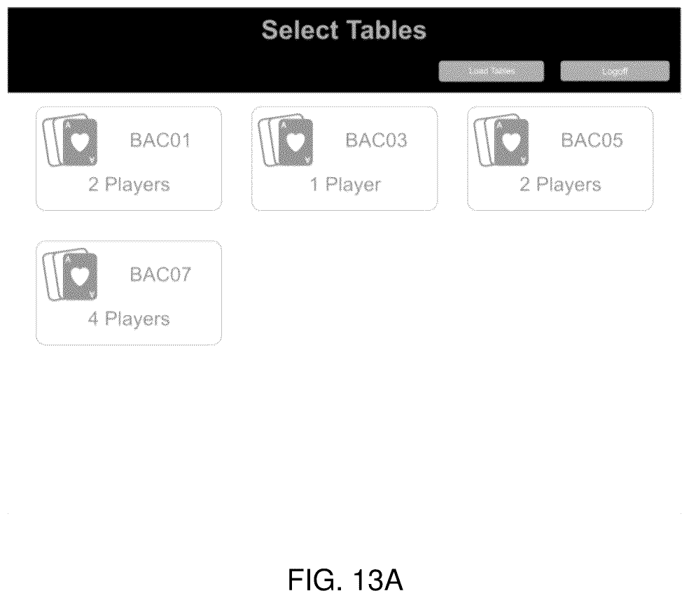

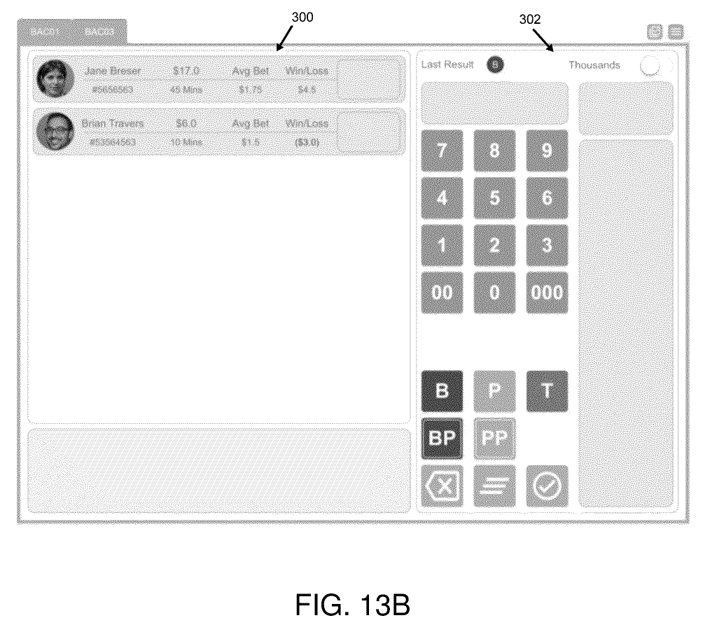

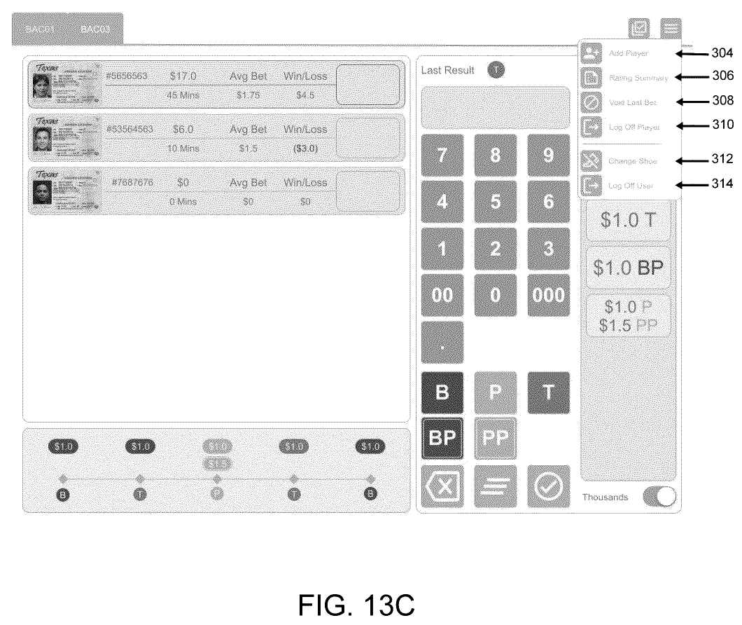

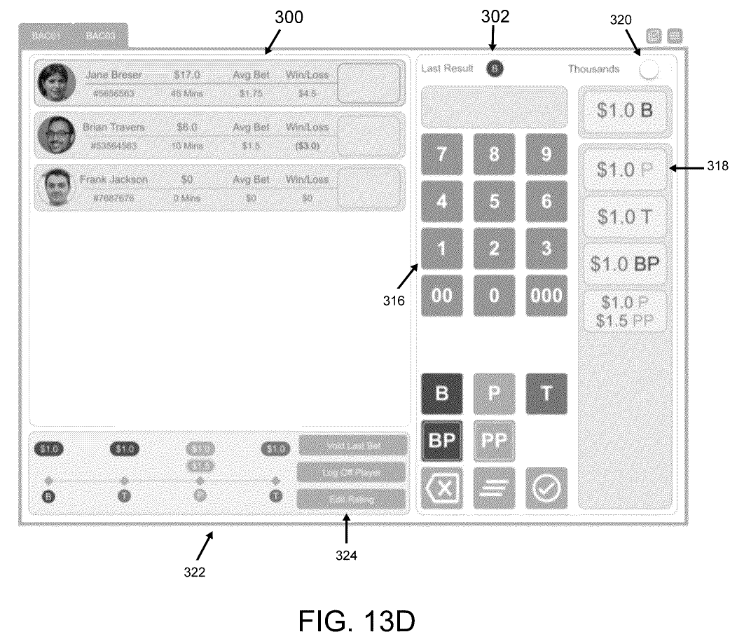

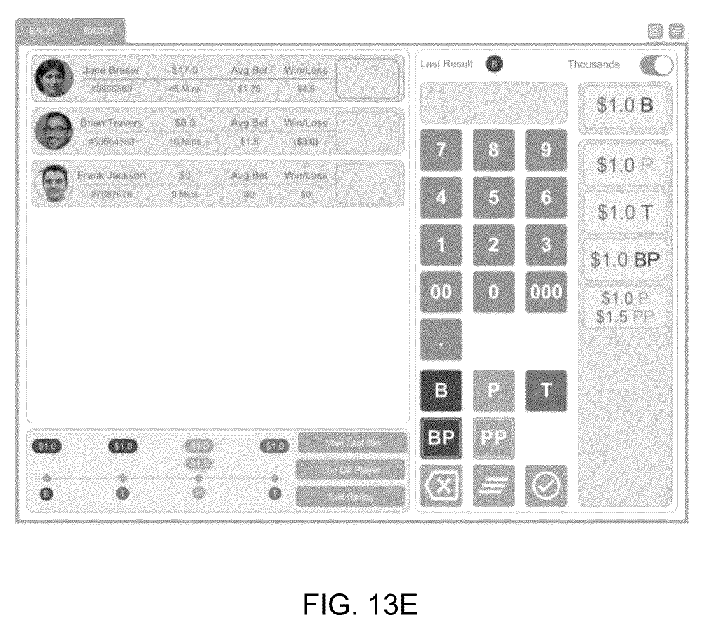

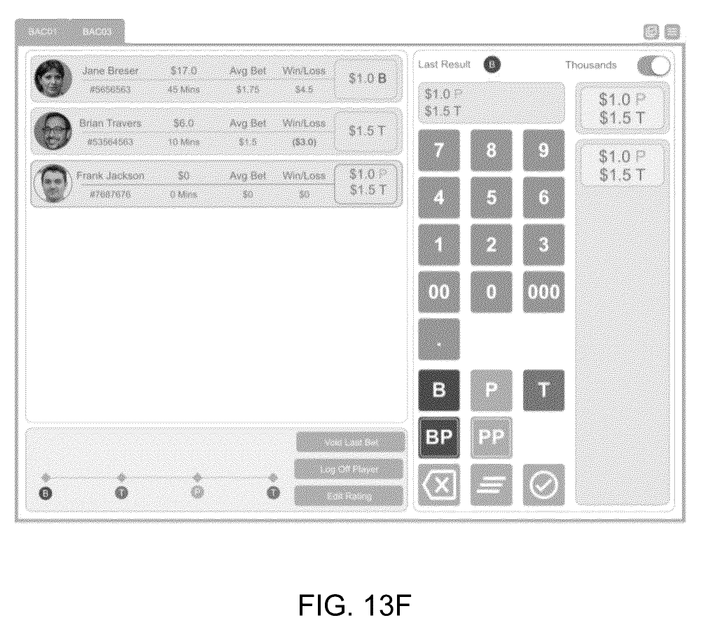

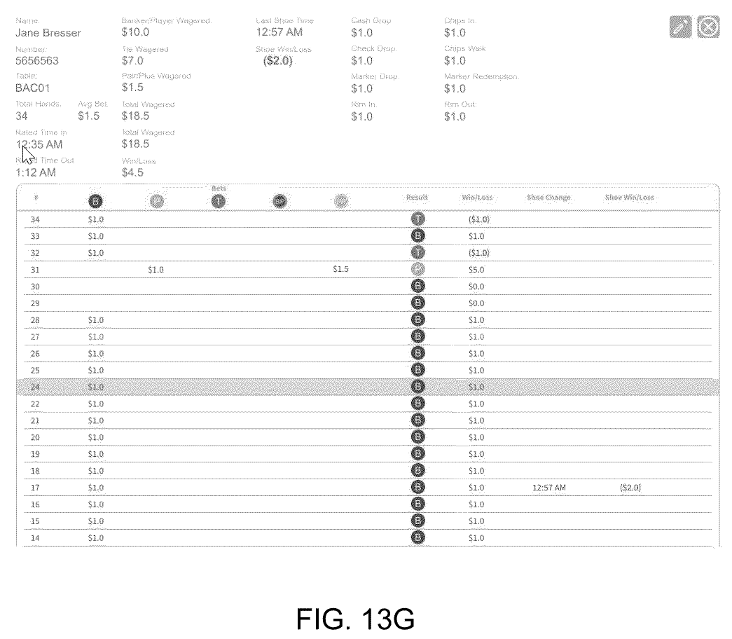

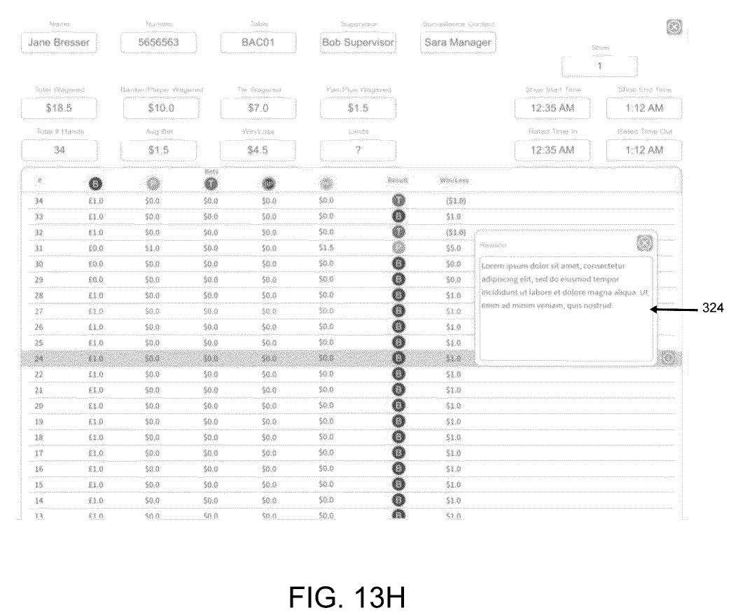

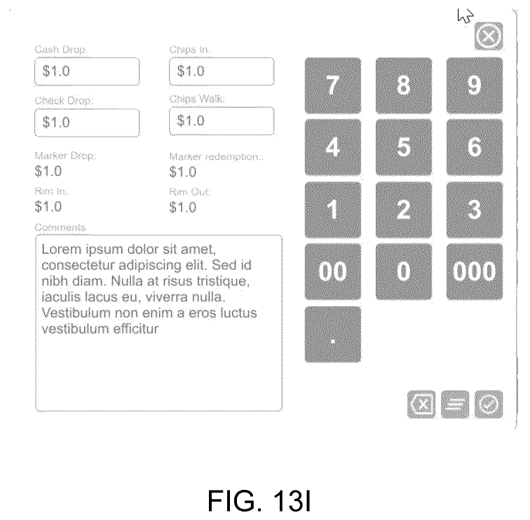

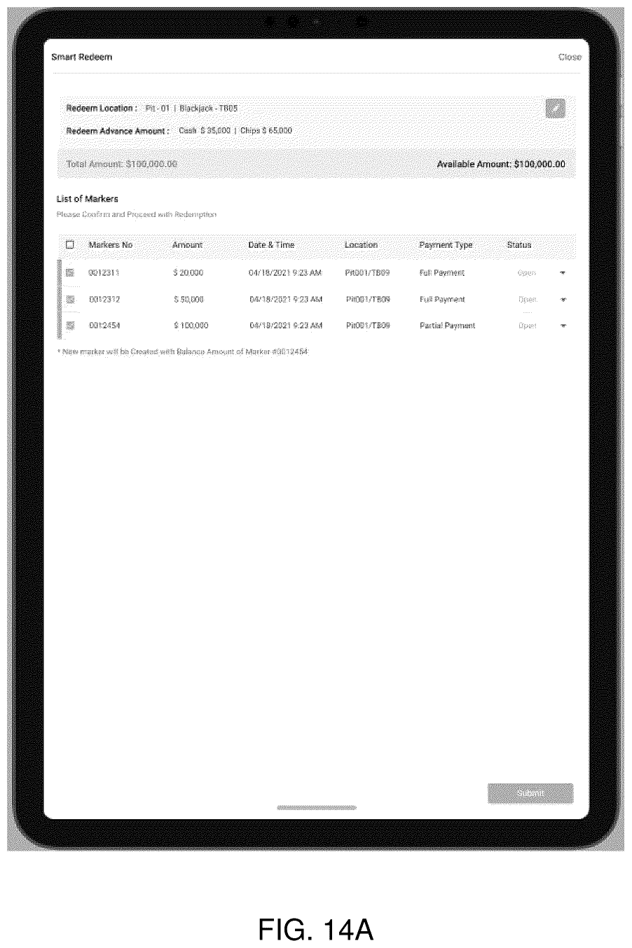

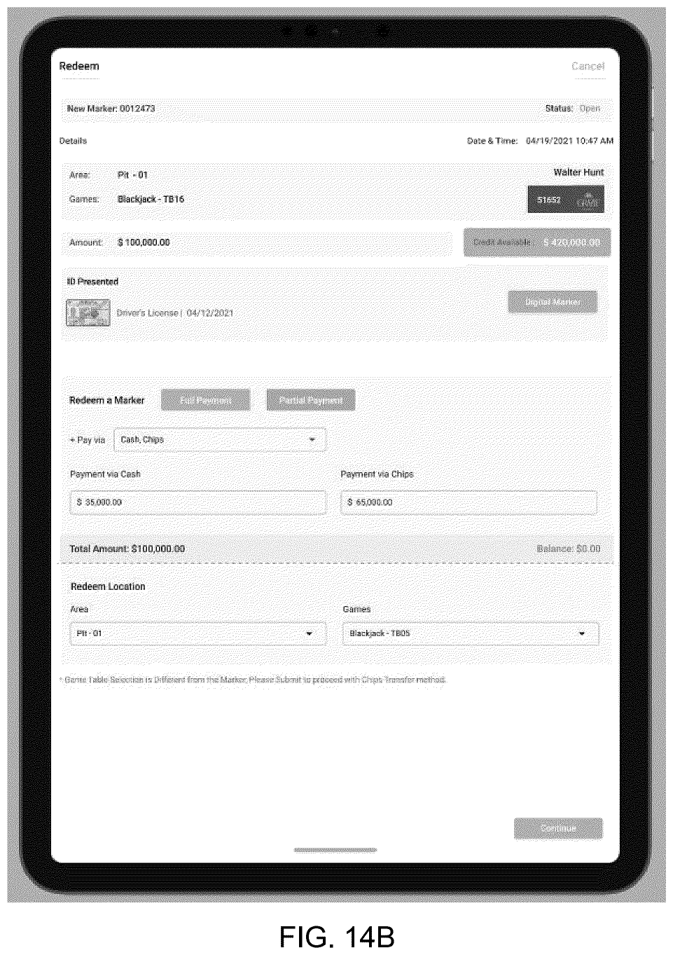

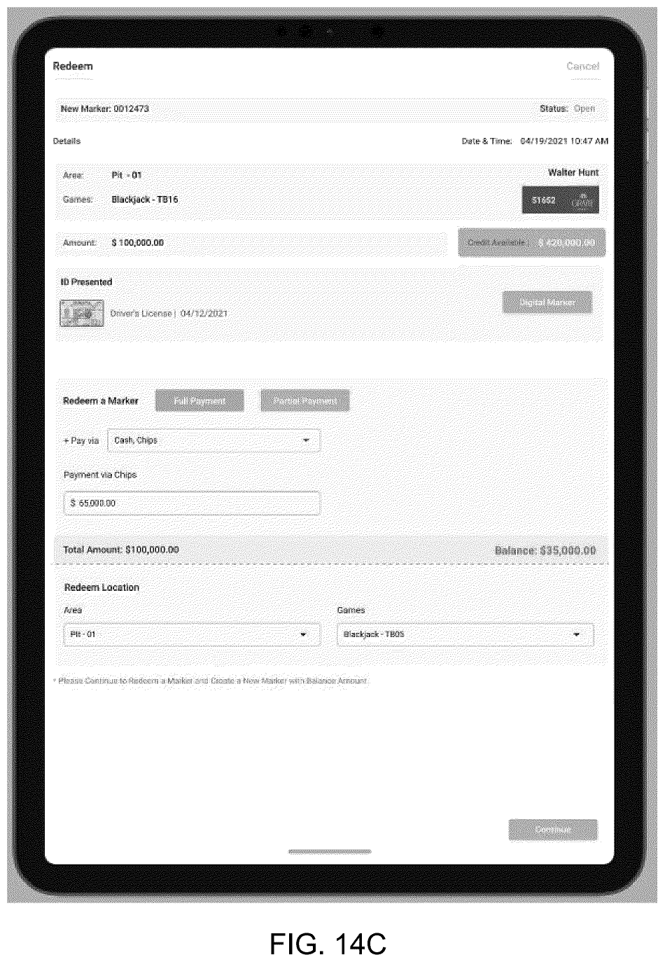

Various functionality that may be implemented by the second sub-system 40, including the second server 42, will be described first with reference to FIGS. 2-10. As illustrated therein, aspects of marker (or other credit, such as rim) processing may be facilitated via the portable processing device 46 (or via a workstation or the like), including by presentation of one or more graphical user interfaces. The interfaces may be generated and display via an application or web-browser, for example, wherein the portable processing device 46 interfaces with the second server 42. For example, in one embodiment, aspects of the invention may be implemented by a progressive web application (PWA) which leverages APIs of a web browser associated with the device (such as running on the portable processing device 46, a laptop or desktop computer or other workstation, etc.)

As illustrated in FIG. 2A, a user, such as a casino attendant, may access the marker processing functionality, such as via a login process, such as via a graphical interface presented on the portable processing device 46. The login process might require the user to identify the location where they are processing markers. For example, as illustrated in FIG. 2B, such might comprise designating a location type, such as a workstation type (“Cage” vs. “Pit”). As illustrated in FIG. 2A, such a designation might comprise, or further comprise, a particular sub-location in the casino, such as “Pit 1”, “Pit 4”, etc., such as indicated or selected by a drop-down selection or other input. As illustrated in FIG. 2A, the login process may require an input of verification or authentication information, such as a user name and password (or via other information, such as a security card scan, biometric input, PIN, registered employee ID, etc.). Information which is input to the portable processing device 46 may be transmitted to the second server 42, such as for validation against stored login information for the attendant.

As illustrated in FIG. 3A, after logging in (e.g. in response to a validation of the login information from the second server 42), a main interface may be displayed to the user. The main interface may include various selectable elements, such as tabs, menus and the like. In one embodiment, the main interface may include a menu button 100 which, when selected, causes the display of a user-side menu 102, such as for the display or selection of various information or actions, such as to view the user's profile, change various settings and/or sign out (in some embodiments, an administration module may be provided separately from the side menu or front end interface, which module facilitates various administrative functions). FIG. 3B illustrates another embodiment interface wherein the menu may allow the user to change the workstation type (such as relative to the configuration described above where a player might designate a workstation type at login, and then desire to change the noted workstation type).

As illustrated in FIG. 4, the main interface may include tabs or buttons associated with a number of specific sub-features or functions, such as: 1) Markers (such as for displaying marker information and creating or generating new markers, as described below); 2) Rim; 3) Track (such as for tracking live or in-game play information); and 4) Queue (such as for displaying and tracking work areas and activities). The main interface may also include other features, such as a “Locate Patron” button 104 (described in more detail below), and may display the present logged-in location 106 for the user.

As illustrated in FIG. 4, the main interface may default to the selection of the “Marker” tab or button, whereby the main interface automatically displays a list of existing markers or other credit elements, along with various information associated with those markers or credit elements (which displayed information might be variable, such as via changes to the settings). For example, the portable processing device 46 may send a request for current marker information to the second server 42 (and/or the second server 42 may “push” the latest marker information to the portable processing device 46). As illustrated, the marker information may include a player/patron ID, the name of the player/patron with which the marker is associated, a location (such as an internal casino location where the marker is being processed), the amount of the marker, a marker document number, a date and time, and a status (such as relative to steps associated with the processing thereof). In one embodiment, the marker information may be color coded, such as to allow the user to more easily identify the status of a particular marker or the status of a particular patron's loyalty status to the casino, including patron loyalty number/identifier). In one embodiment, the marker information may include a timer that indicates an amount of time remaining for completing issuance of the marker (such as in accordance with rules or regulations such as the MICS), such as by obtaining a signature from the patron. The user may be permitted to filter the displayed information (such as by selecting a “filter” button 108, such as by one or more criteria which includes, but is not limited to: markers or credits elements based upon location, player/patron, card number, amount, document number, status, etc.

The use or user may also be permitted to conduct a search of the associated information, such as a search for a particular patron by name. For example, the user may select the “Locate Patron” button 104 (FIG. 4), which may then cause the display of an input box or field which allows the user to input the name of a patron. As illustrated in FIG. 5, this may cause the display of relevant results to the patron search. The locate patron function might enable various functionality, such as dynamic or smart search by patron name (first and/or last), ID number, date of birth, reward card, etc., and in some embodiments, searching may be permitted of all patrons in the system, wherein patrons might be designed as credit or non-credit players, including the ability to filter “credit” players from non-credit players). Search request or requests for information may be transmitted to the second server 42 which conducts a search of data in the database 44, such as of player data records, marker records, rim credit records and the like, as further described herein.

As illustrated in FIG. 6A, the user may select a particular patron to cause the display of detailed information regarding the patron. For example, as illustrated, the selection of a particular patron may cause information to be displayed regarding that patron, such as name, address, credit limit, any collateral provided by the patron, any “front money” provided to the casino, amount of credit outstanding, amount of credit remaining, amount of rim credit pending processing, and player number. As indicated, existing markers for a player may be displayed, including information regarding the status of each marker. This detailed information may be provided by the second server 42 to the portable processing device 46 for display.

As illustrated in FIG. 6A, the patron's ID 110 may be displayed. As illustrated in FIG. 7, by selecting the ID, another interface or a pop-up window may be displayed which displays the patron's ID, such as in a larger format. The user may use this image, for example, to verify the identity of the patron in the process of issuing a marker or rim credit (such as by the user visually comparing the patron's appearance to the picture on their ID, or in other embodiments by verification or authentication involving other systems, such as casino compliance and/or third party verification providers such as VeriDocs).

Referring again to FIG. 6A, the user may also initiate the issuance of a new marker, such as by selecting a “new marker” tab or button 112. The user may, for example, confirm that the amount of credit that the player/patron seeks is available relative to their credit line, such as from the information which is displayed relative to that player/patron.

Another embodiment of an interface is illustrated in FIG. 6B, as illustrated therein, such an interface may permit the user to select a “front money” element (such as a button). The selection of this element may cause the system to generate and display information regarding front money provided to the player, such as in a bottom portion of the interface or in a separate window.

As illustrated in FIG. 8A, when the user elects to generate a new marker, a draft electronic marker (“e-marker”) document is generated. For example, the portable electronic device 46 may send a “create marker” request to the second server 42 of the second sub-system 40 which then generates marker information and transmits it to the portable electronic device 46. This document may include information such as the amount of the marker, the issuer and a marker or document number. The draft marker instrument may be displayed, such as on the display of the portable processing device 46. In one embodiment, in response to a request to create a marker, the second server 42 preferably creates a marker record, such as having an associated marker identifier, which record contains or is linked to relevant marker information, such as the amount, an identification of the associated player, information which identifies the attendant which requested creation of the marker, a location (such as gaming table ID or location, a game name), etc.

In one embodiment, the user must capture the signature of the player in association with the marker. For example, as illustrated, the marker document may be displayed along with a signature area for electronically capturing a signature of the player. The signature might be provided, for example, by the player providing a signature input to a touch screen of the portable processing device 46, such as illustrated in FIG. 8B. As detailed below, this signature may be stored or archived. Further, a verification might be performed on the signature, such as to verify that it is authentic/that of the patron (such as by comparison to a previously collected signature, such as collected when the patron signed up for a casino rewards account or the like).

As illustrated in FIG. 9A, various security features may be associated with the marker issuance process, including a requirement that one or more secondary parties validate the process (beyond the user/attendant). For example, a dealer and a supervisor, or other parties, may be required to validate the marker and its associated information (patron identity, amount, etc.). This prevents, for example, a user from colluding with a patron to fraudulently issue a marker. The third party validation may be provided in various manners, including by requiring those parties to validate their identity and then provide the require validation input. As illustrated in FIGS. 9A and 9B, information may be displayed which indicates whether the secondary party validation of the marker was completed. As indicated above, the security features might also comprise an analysis of the patron's signature, such that it meets required quality standards and/or matches a signature on file (wherein if these criteria are not met, an indication might be provided to have the patron re-sign). As further indicated in FIG. 9A, the interface may be configured to display information regarding a “progress” of the processing of a marker, such as in a graphical format which displays a status of the process in relation to a plurality of steps. This feature enables a user to quickly visually identify the status of a marker that is in process, including what steps of the process have been completed and which remain incomplete. As shown in FIG. 9B, this interface may be updated, such as when the process is completed.

FIG. 10 illustrates one example of a digital marker that has been created in accordance with the present invention, the electronic marker displayed in a graphical format, including information regarding the payee (such as the casino), payor (the player), amount of the marker (such as in dollars and cents) and information indicating the legal nature of the marker. This image may be stored in the database of the second system 40. Once a marker is created, it may be associated with a patron, such as to permit the marker to be shown or identified in a list of markers associated with the patron in a graphical user interface of information relating to the patron.

As illustrated in FIG. 11, selection of the “Queue” tab or button may cause the display of another interface. This interface may display information regarding the internal work flow processing of the markers, such as to one or other systems. For example, assuming that a marker is not immediately redeemed, the marker may be transferred (by sending information electronically) to a casino cage or credit system (such as part of the first sub-system 30).

Referring back to FIG. 4, a user may select the rim button in order to cause the display of an interface of information regarding the status of various rim credits. For example, as illustrated in FIG. 12A, upon selecting the RIM button, a RIM landing page may displayed. This page might display a list of all active rim credits for a particular location (for example, location Pit-01 in this example, which location may be changed as described herein, wherein upon changing the location the rim credits for the newly selected location may be displayed). The displayed information may comprise a RIM identifier (such as RIM number), player ID information, player name, the location, balance, date and time and status. In one embodiment, the user might select a particular rim and a RIM detail interface may be displayed, such as illustrated in FIG. 12B. Such an interface may include detailed information for the particular rim credit (including, like for markers, information regarding the associated player/patron, amount of rim credit, status of the rim credit and/or other information). It will be appreciated that the user may input new rim credit to a patron which can then be viewed and tracked, such as by the selection of a “New RIM” tab or button 116. The selection of this option may result in the display of a sequence of interfaces, such as shown in FIGS. 12C-G, associated with the creation of new rim, including the amount, location, and an approval (such as a signature by a dealer and at least one supervisor, such as a pit supervisor). In one embodiment, this information is input to (such as by input of the information or selecting displayed information) at the portable processing device 46 and may be transmitted to the second server 42. The second server 42 may generate a rim credit record, such as for storage in the database 44. The rim credit record may be assigned a rim credit record ID or the like. Once created, the second server 42 may transmit information regarding the rim credit record to the portable processing device 46, such as for display (such as illustrated in FIGS. 12A and D).

As illustrated in FIG. 12H, the system may facilitate electronic transfer of a rim, such as from one gaming table to another, such as via a displayed interface. This may comprise a request to transfer which is input to the portable processing device 46, such as to the graphical interface thereof. As indicated, the request to transfer may include new location information (such as a table ID or location and type of game, etc.). This information may be transmitted to the second server 42, which may in turn, update the corresponding rim credit record.

In a preferred embodiment, the amount of rim credit comprises an exact amount of the credit that was provided to the player, whereby true amounts of rim credit extended to players are known, and ensuring that associated later issued markers, cash and chips or order to reconcile with the amounts of rim credit extended. Further, if the rim credit is not paid back as required, the user may convert the rim credit to a marker, such as by the selecting the “new marker” feature described above.

In one embodiment, the system is configured to integrate or automate this buy down of a rim to a marker, wherein a new marker may be generated in a similar manner to the process described above. Once the new electronic marker is generated, the system is preferably configured to automatically update the rim within the system, such as by linking it to the newly generated marker and updating any outstanding rim balance for the player.

In one embodiment, the system may also automate the processing of rim cards when a gaming table is closed. For example, if a table is closed when there are one or more open rim credits for players at that table or a table moves to a new gaming day, the system may generate a notification or alert for the user. The system then allows the user to transfer the balance to another table or area (such as a casino zone, pit or high limit to low limit within the same pit, wherein the table or area has the same game theme), or transfer the balance to a new card when a gaming table moves to a new gaming day. The system may also identify and inform users of the approval status of each rim credit, including sign-off status of each rim credit. For example, if a rim credit has not been properly approved/signed-off (such as by a dealer and/or pit supervisor), the system may generate a notice or alert, thus ensuring compliance with that requirement.

A user might also select a report button, such as located in the main menu on the landing page, such as to cause the second sub-system 40 to cause the display (such as via the portable processing device 46) of an interface (such as on the portable processing device 46) which allows the user to select different reports and/or to cause the generation of certain reports, such as relating to markers or rim credits.

In one embodiment, selection of the Track button results in the display of one or more interfaces for displaying bet tracking information, such as live and/or historical betting information of patrons and/or for generating a player rating.

Referring to FIG. 13A, upon selecting the Track button, a Track landing page or interface may be displayed. Such an interface might, for example, display a list of gaming tables. The list might include information which identifies the table, the game being presented at each table and the number of players playing at each table.

As illustrated in FIG. 13A, the user might select a particular table, causing a table interface detail to be displayed, as in FIG. 13B. This interface may display a variety of information, including information regarding the players at the selected table 300 and a user input interface 302, such as for inputting wager information.

As illustrated in FIG. 13C, the interface may include one or more buttons or menus, such as for implementing particular functionality. As one example, the interface might include options for adding a player 304, viewing a player rating summary 306, voiding a last bet 308, logging off a player 310 (such as to remove them from the table), changing the card shoe 312 and/or logging the user off 314.

Selection of the “add player” feature preferably allows the user to add a player to the selected table, such as via the player lookup function described above. FIG. 13C illustrates an example in which the user had added a third player to the selected table.

Referring to FIG. 13D, in one embodiment, the system and method allow a user to enter player wager and associated information (game outcome information, etc.) which is then used by the system to generate detailed bet tracking information, such as for a player, a table, a shoe, etc., as described in more detail below. Preferably, the interface allows a user to enter game play information, such as by a displayed keypad 316 and/or by one or more buttons 318, which buttons may correspond to previously common bet amounts. The keypad 316 might include numerical buttons as well as bet type information (which may vary from game to game, wherein in the baccarat game example, such may including a banker hand wager B, a player hand wager P, a tie wager T, etc.), as well as buttons for other functions, such as delete, clear and enter/complete. In one embodiment, the buttons or “hot buttons” 318 may comprise a combination of bet amount and bet type, such as “$1.0 B”, meaning a $1,000 wager on the banker hand, etc. (including hot buttons which designate more than one bet amount and bet type). These buttons might be configured by the user, or more preferably, may comprise common bet amounts (and may thus change from time to time, such as based upon common bets that a particular player is making, such as being generated by the system, such as by evaluation of common wagers being made by the players of the table, etc.). These preconfigured buttons 318 are thus quick input buttons which save the user time in entering wager information for each player. As also indicated, one or more buttons or selectors 320 may allow the user to change the format of input and displayed amounts, such as from dollars to thousands of dollars (whereby the input or display of an amount “2.5” thus comprises $2,500.00, etc.). As also illustrated in FIG. 13D-F, the interface may include a graphical display of wagers and game outcomes (winning amounts) 322 for a player, such for the last one or more (such as four) games, thus providing an at-a-glance view of a particular player's wagers and outcomes for those games. This same portion of the interface may include buttons 324 for voiding a player's last wager, logging off the player and editing a player rating.

In general, the user utilizes the interfaces to enter betting information into the system for each player, e.g. implementing a “bet tracking” function electronically via the system. Most preferably, the system is configured to generate bet tracking reports from the entered bet information. FIGS. 13G and H illustrate bet tracking reports or “shoe summaries” which may be generated and displayed via the system. Such a report or summary may be generated as to a particular player, and include information such as, but not limited to:
Patron name and information
Table supervisor who logged the patron in
Total amount wagered
Amount wagered on banker/player
Amount wagered on ties
Total number of hands played
Average wager
Win/loss for that session or shoe
Amount wagered on side bets
Which shoe this is for the current play

The interface may also allow a user to select a bet that was inputted erroneously for editing. As illustrated in FIG. 13H, the user may be permitted to enter into the database of stored bet/report information comments 324 or other information, such as comments as to why an entry was corrected, etc.

In one embodiment, the system may generate other reports. For example, the system may use the inputted bet information to generate bet track information relating to a particular card shoe (as indicated above, bet information may be input relative to a particular card shoe, and in the event of a shoe change, the user may select the “change shoe” feature so that a new shoe is selected, thereby associating sub-sets of bet information with particular shoes. Such information may allow a casino to see, for example, profitability on a per shoe basis. Similarly, information may be generated regarding a particular table or group of tables.

In one embodiment, in addition to being able to select and track patrons as indicated above, or separate therefrom, the system may be configured allow a user to directly add information pertinent to adding a ‘Manual Rating’. For example, upon selecting a particular player from the bet tracking interface, an interface such as that illustrated in FIG. 13I may be displayed. This interface may allow the user to input information for use in generating a player rating. Such information can be, but is not limited to, ‘came with’ information (cash, marker, chips, rim in (e.g. a new rim) or rim out (e.g. a transferred rim), etc.), patron information (patron ID, patron name), and credit information (limit, outstanding, front money (FM), availability). The user may also enter information regarding what the patron is walking with (chips, rim outstanding). The system may then be configured to generate a manual player rating, using that “came with” and “walked with” information, preferably along with information regarding the player's game play (such as the bet information described above). The rating may include game play information, such as an exact average bet, win/loss, and time in and out based on the play for the player. This information or rating may be filled in or populated automatically to the patron, eliminating the current fully manual process. The generated rating may then also be moved to the “Queue” where it can be approved by a pit manager and then provided by the system to other systems (such as to a casino customer management system), thus eliminating the need to manually re-input such rating information in the other systems. In one embodiment, in the event the system is offline (such as due to outage or errors), rating support may be manually implemented. The manual rating information may then be input and, when the system is back online, be updated into the system (such as by pushing it to the system of record for the rating information).

Of course the system and method may have other features. For example, the PWA or other software which implements the interfaces described above might implement various associated functionality, as the ability to lock the displayed interface into portrait or landscape orientation (even when the orientation of the associated device, such as the portable processing device 46, is changed), an auto portrait/landscape adjustment features, such as based on content of the displayed interface (i.e. full marker shown to patron so they can read the fine print and to mimic a real marker being presented), the ability to highlight or focus the frame of the screen to distinguish between a patron view vs. an employee user view, etc. For example, as illustrated in FIG. 4, an orientation button 105 may be provided which allows the user to change the orientation of the view, including to lock the view in a designated orientation. In one embodiment, different view orientations may result in the associated interface changing, such as by adding or removing information or changing displayed information or the format of the information.

As illustrated, various information may be displayed by the interfaces, including image information. The image information might comprise, for example, an image of a player (such as from their ID), such as illustrated in FIG. 13E, or might comprise an image of the players actual ID, as illustrated in FIG. 13C. Such image information or other information may aid in the user identifying a player or confirming the identity of a player, etc.

Additional features and advantages of the invention will now be described.

In one embodiment, once a marker is created, information may be stored relative to that marker, such as in the database of the second sub-system 40. In one embodiment, when a patron's signature is obtained, it may be stored separately from the generated e-marker. Only if the player does not pay back or ‘redeem’ the marker in the required period of time may the player's signature be associated with the marker information. This increases the security of the player's information and the associated markers because the player's signature can be maintained in a secure location. If the marker needs to be finalized, such as for printing and presentation to a bank, etc., the player's captured e-signature may be associated with the e-marker.

In accordance with the invention, a process for generating, issuing, tracking and processing markers and other credit such as rim credit, is made purely electronic. Casino personnel no longer need to manually generate paper records for tracking markers or rim credits, and markers are no longer printed paper documents, and can instead print markers as needed (individually or in batch). This also allows the generating, issuance, tracking and processing of such credit (markers, rim credit or the like) to not only be expedited, but comes with increased security and fewer mistakes.

In some jurisdictions, such as the State of Nevada, a patron must sign a marker within a required time from when the marker is generated. The present invention expedites the rate at which a marker can be issued and presented to a player for acceptance and signature, increasing compliance (also, as indicated, specific information regarding the amount of time remaining to gain player acceptance and a signature on a marker may be displayed, helping ensure completion of this step of the process).

One advantage of the system and method is that marker and credit generation, processing and tracking can be made paperless. This has a number of related advantages. For example, once an electronic marker is created in the system, the processing of the marker can be facilitated by other casino personnel (other than the attendant) without having to physically transfer the markers to other departments. For example, stacks of printed markers no longer have to be delivered to a cashier station or the like. In one embodiment, information regarding an electronic marker can then also easily be transferred to entirely different systems, such as to a central credit casino system, AML system, etc.

Another advantage of the system and method wherein e-markers are generated is the ability to cross-share information between systems or features of systems. For example, in one embodiment as described above, a patron may seek credit by filling out a credit application which is processed by the first sub-system 30, such as a casino credit system thereof. During the credit application process, the patron may opt-in to use of electronic signatures. This “opt-in” may be transferred to the second sub-system 40, which thus allows the attendant to capture and use the patron's e-signature relative to the marker issuance process (such avoiding the need for the patron to make such an election at that time, speeding up the process).

Of course, other information may be cross-shared between the sub-systems 30,40. For example, a casino credit first sub-system 30 may transmit information regarding individual patrons, such as information regarding their credit line, to the second sub-system 40 (such as for display as part of the patron information display as in FIG. 6. Likewise, the second sub-system 40 may transmit information to the first sub-system 30. For example, when the second sub-system 40 generates and issues a marker, the amount of the marker may be transmitted to a casino credit first sub-system 30, such as to obtain an approval of the marker by that system and/or update the amount of outstanding credit for that patron.

As another example, the functionality of the system is integrated, such as by linking functionality implemented via different interfaces. As one example, an image of a e-marker may be displayed as a result of the process flow of generating the e-marker. However, as illustrated in FIG. 14A, in the marker redemption process a user might access an image of the marker that is being redeemed (such as in a pop-up window), such as by a “digital marker” button—whereby aspects of the marker generation and marker redemption process are linked and integrated (thus avoiding, for example, the user having to leave one process and go to another process or interface to obtain desired information).

Another advantage of the system is that real-time information can be maintained regarding a patron and the status of their credit. For example, under current manual tracking systems, a patron might seek issuance of a line of credit at one gaming table and then move to another table and seek additional issuances or instances of credit, where the second amount of credit may go over the patron's credit line. The attendant who is processing the second request may not be aware of the first request. In accordance with the present invention, all requests for credit (including rim credit) for a patron are tracked and can be nearly instantaneously updated by the second sub-system 40.

Another aspect of the invention, and one that is particularly applicable to a system in which markers are electronically generated and processed as described above, is an automated method for marker redemption (which may be referred to as smart or intelligent marker redemption). For example, as illustrated in FIG. 6, the interface may include a “Smart Redeem” button or tab 114 which, when selected, enables or initiates the functionality described below.

In one embodiment, the system 20, such as the second sub-system 40, is configured to settle a single marker or multiple markers in full or via partial marker redemption. In one embodiment, the method may comprise the following steps:
(1) Player/patron requests to pay down/off an existing marker. Such a payment might be made by the player at a casino cage or pit (such as to an attendant who interfaces to the system in the manner above, such as via a mobile processing device or a workstation) such as by the presentation of chips for redemption, or other forms of payment including, but not limited to cash, checks, etc. In other embodiment, the player might also seek to make a marker payment via a wallet application or other electronic interface or application, such as where the payment is to be made electronically.
(2) In the case of an in-person payment, the attendant may locate a patron within the patron (such as via a patron look-up via an interface as described above, which interface may then also display a list of markers associated with the player) and select the applicable marker, such as by selecting a “player payment” option or the like relative thereto. The attendant may input a method of payment (e.g. cash or chips, etc.) and the amount of the payment.
(3) In one embodiment, the system then calculates a difference between the amount of the payment and the amounts or value of the marker.

The system preferably then implements a payoff process which is based, at least in part, upon the amount of the payment in relation to the marker amount, wherein:
A) When the payment and the amount of the marker is equal, then the system is configured to allocate the payment to the marker to pay it off.
(B) When the payment amount is less than the amount of the marker, then the system may be configured to implement a partial payoff of applicable marker initially selected by the attendant. In such a configuration, the existing marker may then be closed and a new marker may be issued (preferably electronically, such as via the process noted above) for the remaining unpaid balance of the original marker (and otherwise in accordance with applicable rules/regulations).

In one embodiment, the system may be configured to process a payment by a player who has multiple outstanding markers. Again, the attendant may locate the patron in the system and may input the amount of the payment being made. In this embodiment, the system may implement a payoff process which is based, at least in part, upon the amount of the payment in relation to the amounts or values of the multiple markers and an age or order of those markers, such as wherein:
(A) When the payment amount equals the total amount of all outstanding markers, the system is preferably configured to redeem all of the markers, preferably using a first in/first out (FIFO) rule (as to date of marker creation, whereby the oldest marker is redeemed first).
(B) When the payment is less that the amount or value of all of the markers, the system is preferably configured to redeem as many markers as funds permit, preferably utilizing the FIFO rule (e.g. starting with the oldest marker first). Once again, if the amount of the payment is insufficient to pay even the oldest marker, the payment is made against the oldest marker, that marker is closed and a new marker is issued for the remaining unpaid balance of that marker. If the payment is sufficient to pay one or more markers, those markers and paid, any partial payment to a marker is again made along with the issuance of a new marker for the partial balance and any unpaid markers simply remain in the system as unpaid.

In a preferred embodiment, the system is configured to apply the player's payment to or “redeem” the one or more markers in a default order. In some embodiments, however, an attendant might be permitted to override the payment order (for example, relative to multiple markers, the attendant might override the system and apply a player's payment to the newest marker).

As indicated above, in some embodiments, a player might make a payment electronically, such as via a kiosk or wallet application (e.g. without an attendant). In such configurations, the player may use the kiosk (such as which interfaces to the system 20, such as the second sub-system 40) or wallet to input a payment (such as from a wallet account, bank account, credit card, etc.). The system may then auto-apply the payment in the manner described above.

In one embodiment, the system is configured to update the status of each paid or redeemed marker in the system, including by updating the associated record thereof (and any image thereof might also be updated, such as to include a watermark of payment, etc.). Further, in a preferred embodiment, the system may be configured to generate and provide to the player a receipt confirming payment to the applicable one or more markers. The delivery of the receipt might be by printing the receipt, or electronically, such as by email or SMS (in some embodiments, the player may be provided with an email or SMS notification which allows the player to securely download the receipt, such as in PDF form, such as with PIN or other security elements). In other embodiments, the receipt might be made available to the player via their electronic wallet or other account, wherein the player may login and not only see the status of their one or more markers, but download and/or print information regarding those markers, such as payment receipts therefor).

In one embodiment, information regarding the redemption process, including information related thereto and inputs, may be displayed via one or more interfaces. For example, as illustrated in FIG. 14A, selection of a redeem function may cause an interface to display information regarding outstanding markers for a particular location, such as a particular designated location. As illustrated in FIGS. 14B and C, the user may then select the marker that a player desires to redeem, and an interface may display information regarding a redemption process for the marker, which process may permit the user to designate a full marker redemption (for example, where the outstanding marker amount is $100,000 and the player is providing $35,000 in cash and $65,000 in chips) or a partial marker redemption (for example, where the outstanding marker amount of $100,000 and the player is paying $65,000 in chips towards that marker balance).

In one embodiment, when a patron seeks credit or seeks a marker, a patron casino account, such as an e-wallet, may be created for the patron at the same time. This casino account or wallet may be used to track player funds, including funds provided by the patron and funds provided to the patron, as well as interface with external systems such as banking systems for transfers of funds between a patron's credit card or bank account and the wallet. In this embodiment, when a patron is granted credit via a marker, the funds may be associated with their wallet. The patron may then access funds from the wallet (including, for example, by seeking transfer of funds from the wallet to a gaming machine or to a table for conversion to chips, etc.). The patron may also then access their wallet to see the status of any markers issued to them, including information such as redemption deadlines and amounts, and may also transfer funds from their wallet to a marker, such as to pay it off.

The present invention may include other features, such as the ability of the patron to access and view, such as via a web-portal or application, real-time status of their markers. The present invention may also be configured to enable other features, such as other data analytics features and the ability to generate outputs (such as graphical displays) of such analytics. Such may comprise, for example, analytics relating to the markers by area (casino pit, casino table, zone, etc.), heatmaps and other features.

Currently, when a paper marker is paid off, it may be given back to the patron for destruction (and to ensure that the casino cannot cash/collect on it). In one embodiment, when an e-marker is paid off, the system may send a confirmation to the patron, such as a receipt or other confirmation by text, email or the like, thus ensuring that the patron has a record of the payment of the marker.

As indicated above, in one embodiment, the second sub-system 40 may link to a wagering or tracking system 32, or directly to the gaming tables 22, gaming machines 24 or the like, including features thereof. This allows the second sub-system 40 to gain information regarding player play. In one embodiment, this allows the second sub-system 40 to gain real-time accurate information regarding a player's play (amounts wagered, play strategy, amounts won/lost, etc.). This information might be used by the system, or as provided to the first sub-system 30 such as a credit system, to manipulate a player's credit line or the like. In other embodiments, the portable processing device 46 may be configured to display one or more interfaces which easily allow an attendant to input such information, such as by viewing play at a gaming table.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A centralized system for electronically processing casino player rim credit relative to players at a plurality of gaming tables, comprising:
a plurality of mobile attendant devices, each mobile attendant device communicable with and separate from said gaming tables, said attendant device comprising a processor configured to execute machine readable code, a memory, a display device, at least one user input device configured to receive user input relative to a graphical interface displayed by said display device, and machine-readable code stored in said memory;
a database;
a processing server comprising a processor configured to execute machine readable code, a memory, a communication interface, and machine readable code stored in said memory said executable by said processor, said processing server communicatively coupled to said database and said plurality of mobile attendant devices;
said machine readable code of said mobile attendant device configured to cause said processor thereof to receive input from a user of one of the plurality of mobile attendant devices relative to the graphical interface displayed by the mobile attendant device of rim credit identification information comprising a designation of one of said players, a game location and an amount of rim credit provided to said player;
said machine readable code of said processing server configured to, in response to receiving said rim credit identification information from said one of said mobile attendant devices, cause said processor thereof to generate an electronic rim credit record which comprises at least said game location and said amount of said rim credit provided to said player and store, in said database in association with a player identifier of said player and other rim credit records corresponding to said player, said rim credit record, and generate a rim credit balance representing unpaid rim credit to said player based upon said rim credit record and said other rim credit records; and
transmit, to said plurality of mobile attendant devices information to cause said plurality of mobile attendant devices to display at least one of: a) a list of rim credit records corresponding to said players which has been updated to include said generated rim credit record, wherein each rim credit record in said list of rim credit records corresponding to said players comprises at least a rim credit record identifier, information identifying said player to which the rim credit corresponds, and said amount of said rim credit corresponding thereto, and b) a list of rim credit records corresponding to said player as updated to include said generated rim credit records, wherein each rim credit record in said list of rim credit records corresponding to said player comprises at least a rim credit identifier and said amount of said rim credit corresponding thereto, whereby generation of said rim credit record based upon input to said one of said mobile attendant devices causes updated rim credit information to be centrally updated and displayed by said plurality of mobile attendant devices.

2. The system in accordance with claim 1, wherein said processing server is configured to receive at least one supervisor signature input to said one of said plurality of mobile attendant devices by other than an operator of said mobile attendant device, and wherein said processing server stores said least one supervisor signature in association with said generated rim credit record.

3. The system in accordance with claim 1, wherein said game location comprises a gaming table identifier and an identification of a game played by said player at one of said gaming tables.

4. The system in accordance with claim 1, wherein said machine readable code of said processing server is configured to cause said processor thereto to receive input from one of said mobile attendant devices of a transfer of rim credit associated with a displayed rim credit record to a new location.

5. The system in accordance with claim 4, wherein said input comprises identification of a different one of said gaming tables.

6. The system in accordance with claim 5, wherein said machine readable code of said processing server is configured to cause said processor thereof to update said displayed rim credit record with said new game location.

7. The system in accordance with claim 1, wherein said machine readable code of said processing server is configured to cause said processor to receive input from one of said mobile attendant devices of a payment towards said amount of rim credit.

8. The system in accordance with claim 7, wherein said input of said payment comprises a payment amount and a payment type.

9. The system in accordance with claim 1, wherein said machine readable code of said processing server is configured to cause said processor to receive input from one of said plurality of mobile attendant devices of a request for a marker to said one of said players.

10. The system in accordance with claim 9, wherein said machine readable code of said processing server is configured to cause said processor thereof to, in response to receiving said request for a marker, to generate an electronic marker record and store information regarding said marker record in said database.

11. The system in accordance with claim 10, wherein said machine readable code of said processing server is configured to cause said processor thereto to receive a signature of said player relative to said marker.

12. The system in accordance with claim 11, wherein said machine readable code of said processing server is configured to cause said processor thereof to store said signature in association with said marker record.

13. The system in accordance with claim 12, wherein said machine readable code of said processing server is configured to cause a printer to print said marker with said signature associated therewith.

14. The system in accordance with claim 10, wherein said machine readable code of said processing server is configured to credit said amount of said rim credit and close said corresponding rim credit record based upon issuance of said marker.

15. The system in accordance with claim 1, wherein said mobile processing device is configured to display information regarding a player record corresponding to said player, said player record comprising information regarding one or more rim credits issued to said player and one or more markers issued to said player.

16. The system in accordance with claim 1, wherein said processing server is in communication with a gaming system.

17. The system in accordance with claim 16, wherein said gaming system comprises a casino accounting system.

18. The system in accordance with claim 1, wherein said input from said user of said game location comprises selecting by the user said game location from a plurality of game locations displayed by said display device of said mobile attendant device.
